(19) United States
(12) Patent Application Publication
(10) Pub. No.: US 2015/0066460 A1
(43) Pub. Date: Mar. 5, 2015

(54) STRATIGRAPHIC FUNCTION

(71) Applicants: Jimmy Klinger, Perols (FR); Laurent Souche, Montpellier (FR)

(72) Inventors: Jimmy Klinger, Perols (FR); Laurent Souche, Montpellier (FR)

(21) Appl. No.: 14/472,505

(22) Filed: Aug. 29, 2014

Related U.S. Application Data
(60) Provisional application No. 61/871,931, filed on Aug. 30, 2013.

(51) Int. Cl. G06F 17/50; G01V 99/00

(52) U.S. Cl. CPC G06F 17/5018; G01V 99/005
USPC 703/2

(57) ABSTRACT

A method can include receiving implicit function values at nodes of a coarse mesh of a region of interest in a geologic environment; receiving data: formulating constraints based at least in part on the data; solving a system of equations for a finer mesh subject to the constraints; and outputting implicit function values at nodes of the finer mesh based at least in part on solving the system of equations.

### RELATED APPLICATION

This application claims priority to and the benefit of a U.S. Provisional Patent Application having Ser. No. 61/871,931, filed 30 Aug. 2013, which is incorporated by reference herein.

### BACKGROUND

Phenomena associated with a sedimentary basin may be modeled using a mesh, a grid, etc. As an example, a structural model may be created based on data associated with a sedimentary basin. For example, where a basin includes various types of features (e.g., stratigraphic layers, faults, etc.), data associated with such features may be used to create a structural model of the basin. Such a model may be a basis for analysis, further modeling, etc. Various technologies, techniques, etc., described herein pertain to structural modeling, structural models, etc.

### SUMMARY

A method can include receiving implicit function values at nodes of a coarse mesh of a region of interest in a geologic environment; receiving data; formulating constraints based at least in part on the data; solving a system of equations for a finer mesh subject to the constraints; and outputting implicit function values at nodes of the finer mesh based at least in part on solving the system of equations. A system can include a processor; memory operatively coupled to the processor; and one or more modules that include instructions stored in the memory and executable by the processor to instruct the system where the instructions include instructions to: receive implicit function values at nodes of a coarse mesh of a region of interest in a geologic environment; receive data; formulate constraints based at least in part on the data; solve a system of equations for a finer mesh subject to the constraints to provide a solution; and output implicit function values at nodes of the finer mesh based at least in part on a solution the system of equations. One or more computer-readable storage media can include computer-executable instructions to instruct a computing device where the instructions include instructions to: receive implicit function values at nodes of a coarse mesh of a region of interest in a geologic environment; receive data; formulate constraints based at least in part on the data; solve a system of equations for a finer mesh subject to the constraints to provide a solution; and output implicit function values at nodes of the finer mesh based at least in part on a solution the system of equations. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system;

FIG. 3 illustrates examples of conformities and unconformities;

FIG. 4 illustrates an example of a system and an example of a method;

FIG. 5 illustrates examples of formulations;

FIG. 6 illustrates examples of methods;

FIG. 7 illustrates an example of a mesh in a volume of interest;

FIG. 8 illustrates an example of volume attribute values in a volume of interest;

FIG. 9 illustrates an example of a method;

FIG. 10 illustrates an example of a method;

FIG. 11 illustrates an example of a method;

FIG. 12 illustrates an example of a method;

FIG. 13 illustrates an example of a method;

FIG. 14 illustrates an example of a method;

FIG. 15 illustrates examples of retrogradation, aggradation and progradation;

FIG. 16 illustrates an example of a geologic environment;

FIG. 17 illustrates an example of a method;

FIG. 18 illustrates an example of a stratigraphy function and an example of stratigraphy transformed to a Wheeler space;

FIG. 19 illustrates an example of a method;

FIG. 20 illustrates an example of a method;

FIG. 21 illustrates an example of a method; and

FIG. 22 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

Phenomena associated with a sedimentary basin (e.g., a subsurface region, whether below a ground surface, water surface, etc.) may be modeled using a model or models. As an example, a structural model of a basin may find use for understanding various processes related to exploration and production of natural resources (estimating reserves in place, drilling wells, forecasting production, etc.). As an example, a structural model may be used as a basis for building a model for use with a numerical technique.

For application of a numerical technique, equations may be discretized using a grid that includes nodes, cells, etc. To represent features in a geologic environment, a structural model may assist with properly locating nodes, cells, etc. of a grid for use in simulation using one or more numerical techniques. As an example, a structural model may itself include a mesh, which may, at times be referred to as a grid. As an example, a structural model may provide for analysis optionally without resorting to creation of a grid suited for discretization of equations for a numerical solver (e.g., consider a structured grid that may reduce computational demands, etc.).

As to numerical techniques, a numerical technique such as the finite difference method can include discretizing a 1D differential heat equation for temperature with respect to a spatial coordinate to approximate temperature derivatives (e.g., first order, second order, etc.). Where time is of interest, a derivative of temperature with respect to time may also be provided. As to the spatial coordinate, the numerical technique may rely on a spatial grid that includes various nodes where a temperature will be provided for each node upon solving the heat equation (e.g., subject to boundary conditions, generation terms, etc.). Such an example may apply to multiple dimensions in space (e.g., where discretization is applied to the multiple dimensions). Thus, a grid may discretize a volume of interest (VOI) into elementary elements (e.g., cells or grid blocks) that may be assigned or associated with properties (e.g. porosity, rock type, etc.), which may be germane to simulation of physical processes (e.g., fluid flow, reservoir compaction, etc.).

As another example of a numerical technique, consider the finite element method where space may be represented by one dimensional or multidimensional “elements”. For one spatial dimension, an element may be represented by two nodes positioned along a spatial coordinate. For multiple spatial dimensions, an element may include any number of nodes. Further, some equations may be represented by certain nodes while others are represented by fewer nodes (e.g., consider an example for the Navier-Stokes equations where fewer nodes represent pressure). The finite element method may include providing nodes that can define triangular elements (e.g., tetrahedra in 3D, higher order simplexes in multidimensional spaces, etc.) or quadrilateral elements (e.g., hexahedra or pyramids in 3D, etc.), or polygonal elements (e.g., prisms in 3D, etc.). Such elements, as defined by corresponding nodes of a grid, may be referred to as grid cells.

Yet another example of a numerical technique is the finite volume method. For the finite volume method, values for model equation variables may be calculated at discrete places on a grid, for example, a node of the grid that includes a “finite volume” surrounding it. The finite volume method may apply the divergence theorem for evaluation of fluxes at surfaces of each finite volume such that flux entering a given finite volume equals that leaving to one or more adjacent finite volumes (e.g., to adhere to conservation laws). For the finite volume method, nodes of a grid may define grid cells.

As mentioned, where a sedimentary basin (e.g., subsurface region) includes various types of features (e.g., stratigraphic layers, faults, etc.) where nodes, cells, etc. of a mesh or grid may represent, or be assigned to, such features. As an example, consider a structural model that may include one or more meshes. Such a model may serve as a basis for formation of a grid for discretized equations to represent a sedimentary basin and its features.

As to a stratigraphic sequence, a sedimentary basin may include sedimentary deposits grouped into stratigraphic units, for example, based on any of a variety of factors, to approximate or represent time lines that place stratigraphy in a chronostratigraphic framework. While sequence stratigraphy is mentioned, lithostratigraphy may be applied, for example, based on similarity of lithology of rock units (e.g., rather than time-related factors).

As an example, a mesh may conform to structural features such as, for example, Y-faults, X-faults, low-angle unconformities, salt bodies, intrusions, etc. (e.g., geological discontinuities), to more fully capture complexity of a geological model. As an example, a mesh may optionally conform to stratigraphy (e.g., in addition to one or more geological discontinuities). As to geological discontinuities, these may include model discontinuities such as one or more model boundaries. As an example, a mesh may be populated with property fields generated, for example, by geostatistical methods.

In general, a relationship may exist between node spacing and phenomenon or phenomena being modeled. Various scales may exist within a geologic environment, for example, a molecular scale may be on the order of approximately 10⁻⁸ to approximately 10⁻⁸ meters, a pore scale may be on the order of approximately 10⁻⁶ to approximately 10⁻³ meters, bulk continuum may be on the order of approximately 10⁻³ to approximately 10⁻² meters, and a basin scale on the order of approximately 10³ to approximately 10⁵ meters. As an example, nodes of a mesh may be selected based at least in part on the type of phenomenon or phenomena being modeled (e.g., to select nodes of appropriate spacing or spacings). As an example, nodes of a grid may include node-to-node spacing of about 10 meters to about 500 meters. In such an example, a basin being modeled may span, for example, over approximately 10³ meters. As an example, node-to-node space may vary, for example, being smaller or larger than the aforementioned spacings.

Some data may be involved in building an initial mesh and, thereafter, a model, a corresponding mesh, etc. may optionally be updated in response to model output, changes in time, physical phenomena, additional data, etc. Data may include one or more of the following: depth or thickness maps and fault geometries and timing from seismic, remote-sensing, electromagnetic, gravity, outcrop and well log data. Furthermore, data may include depth and thickness maps stemming from facies variations.

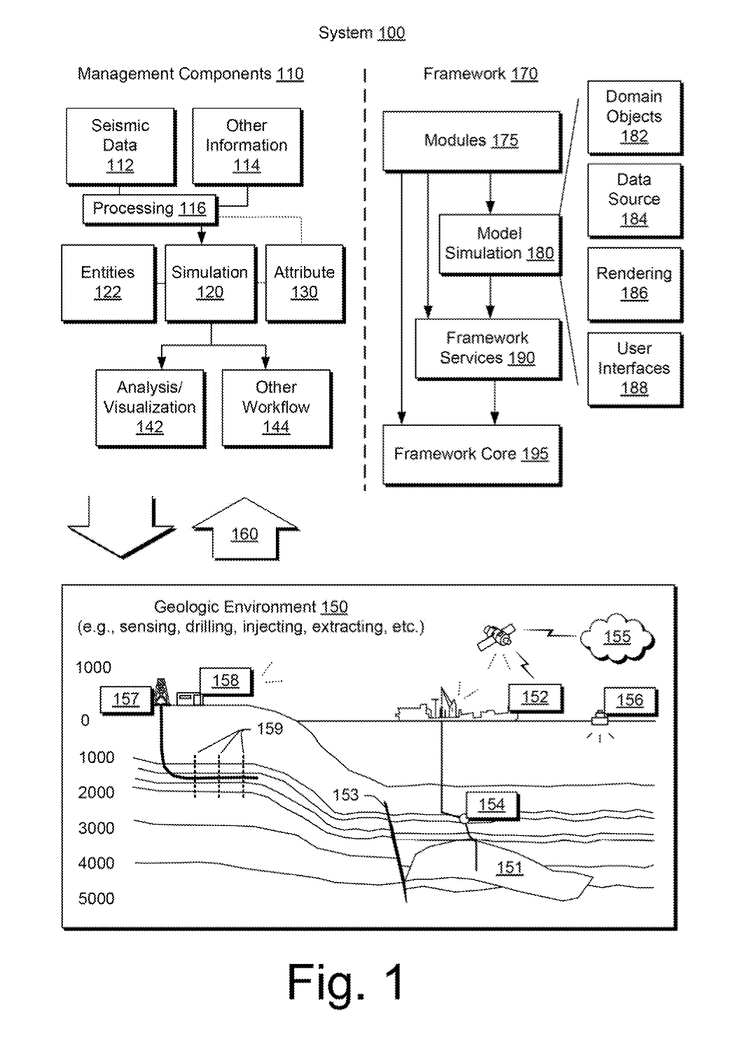

FIG. 1 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETRELS software may be considered a data-driven application. The PETREL® software can include a framework for model building and visualization. Such a model may include one or more grids.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and that may be intersected by a fault 153. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., extemal executable code, etc.).

As an example, a method may include structural modeling, for example, building a structural model, editing a structural model, etc. of a geologic environment. As an example, a workflow may include providing a structural model prior to construction of a grid (e.g., using the structural model), which may, in turn, be suitable for use with one or more numerical techniques. As an example, one or more applications may operate on a structural model (e.g., input of a structural model).

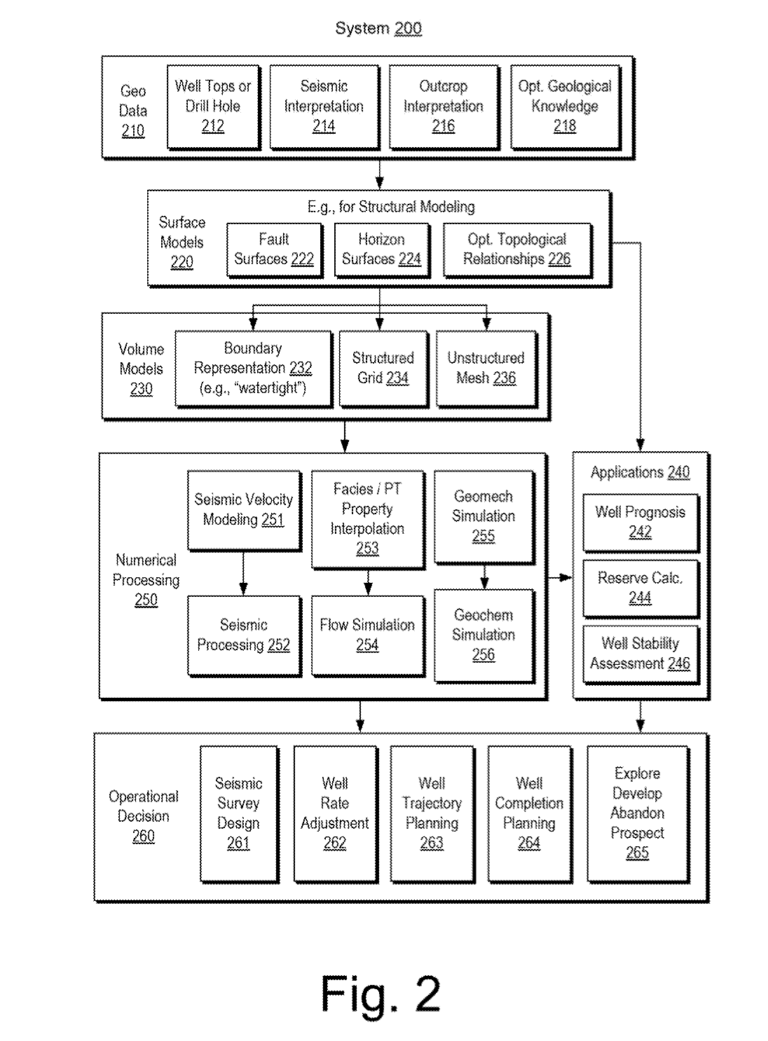

FIG. 2 shows an example of a system 200 that includes a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the one or more boundary representations 232, they may include a numerical representation in which a subsurface model is partitioned into various dosed units representing geological layers and fault blocks wherein an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g. porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., In the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill-bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

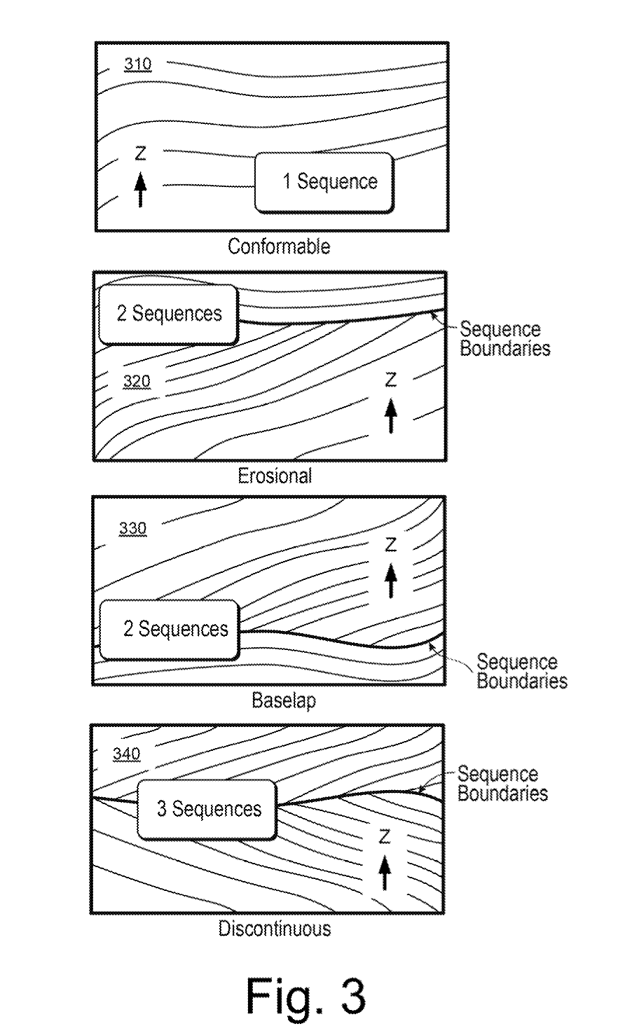

FIG. 3 shows examples of formations that include one or more sequences, for example, sequences of sedimentary structures (e.g., strata, horizons, etc.) occurring in sedimentary rocks. As shown in FIG. 3, the formation 310 includes a single sequence, the formations 320 and 330 each include two sequences and the formation 340 includes three sequences, the middle sequence being collapsed into a single discontinuity surface.

As an example, a conformable horizon may be a horizon between a lower horizon and an upper horizon where the horizons have undergone a relatively common geologic history, for example, being deposited in succession (e.g., continuous in time). Referring to the formation 310, the horizons do not intersect one another and each of the horizons may be considered conformable to adjacent horizons (e.g., lower and upper or older and younger).

As an example, erosion may act to denude rock, for example, as a result of physical, chemical and/or biological breakdown and/or transportation. Erosion may occur, for example, as material (e.g., weathered from rock, etc.) is transported by fluids, solids (e.g., wind, water or ice) or mass-wasting (e.g., as in rock falls and landslides). Referring to the formation 320, of the two sequences shown, the lower sequence may have been eroded and the upper sequence deposited on top of the eroded lower sequence. In such an example, the boundary between the two sequences may be referred to as an erosion; noting that it is conformable to the upper, younger sequence. As an example, erosion may act to “truncate” a sequence of horizons and to form surface upon which subsequent material may be deposited (e.g., optionally in a conformable manner).

As an example, a baselap may be a type of feature in a formation, for example, such as a downlap or an onlap. As an example, a downlap may be a termination of more steeply dipping overlying strata against a surface or underlying strata that have lower apparent dips. For example, a downlap may be seen at the base of prograding clinoforms and may represent progradation of a basin margin. As to an onlap, for example, it may be a termination of shallowly dipping, younger strata against more steeply dipping, older strata (e.g., sequence stratigraphy that may occur during periods of transgression). Referring to the formation 230, given the indicated direction “z” as depth, the type of baselap shown may be considered as a downlap (e.g., lower strata having lower apparent dips). In such an example, the baselap boundary is conformable to immediately older horizons (lower sequence).

As to the formation 340, it includes three sequences and may be referred to as a discontinuity as the boundary is neither conformable to older horizons nor to younger ones. In the examples of FIG. 3, erosions, baselaps and discontinuities may be referred to as unconformities or non-conformable horizons (e.g., or surfaces, layers, etc.).

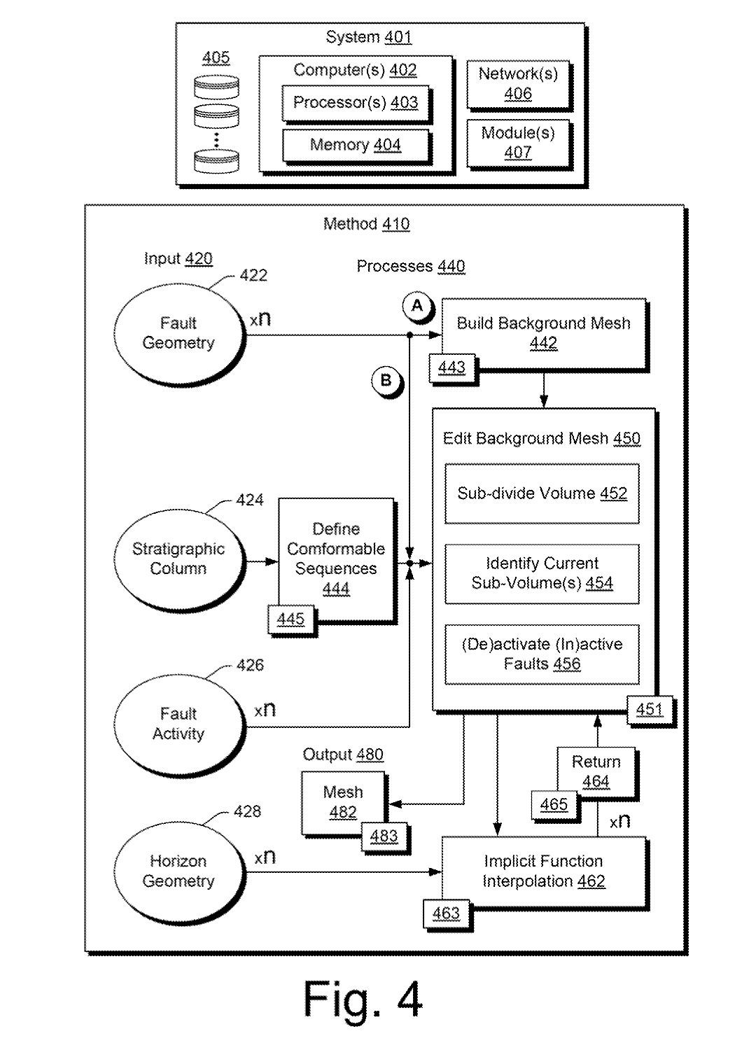

FIG. 4 shows an example of a system 401 and a method 410. As shown in FIG. 4, the system 401 includes one or more computers 402, one or more storage devices 405, one or more networks 406 and one or more modules 407. As to the one or more computers 402, each computer may include one or more processors (e.g., or processing cores) 403 and memory 404 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, data may be provided in the storage device(s) 405 where the computer(s) 402 may access the data via the network(s) 406 and process the data via the module(s) 407, for example, as stored in the memory 404 and executed by the processor(s) 403.

As an example, a system may include receiving information. For example, a component of a system may include receiving information via a bus, a storage device, a network interface, etc. As an example, where instructions execute via a processor, the processor may receive information. For example, a processor may receive data. As an example, data may correspond to measured data, synthetic data, constructed data, etc. As an example, data may be attribute data. As an example, data may describe a model. As an example, data may describe a mesh. As an example, data may define an implicit function. As an example, data may define a stratigraphic function. As an example, a processor may provide information by receiving the information, by generating the information, etc.

As shown in FIG. 4, the method 410 includes input 420, processes 440 and output 480. As to the input 420, the method 410 may receive, for example, fault geometry input per an input block 422, stratigraphic column input per an input block 424, fault activity input per an input block 426 and horizon geometry input per an input block 428. As indicated, the processes 440 can include a build block 442 for building a background mesh, a definition block 444 for defining conformable sequences, an edit block 450 for performing one or more edit procedures per blocks 452, 454 and 456, an implicit function interpolation block 462 for interpolating an implicit function (e.g., or implicit functions) and a return block 464, which may return to the edit block 450, for example, after performing one or more interpolations per the implicit function interpolation block 462. As an example, the method 410 can include outputting a mesh as output 480 per a mesh output block 482, for example, where the output mesh may be suitable for one or more purposes.

As an example, the method 410 may include receiving a background mesh (e.g., built per the mesh block 442), receiving one or more conformable sequences (e.g., defined per the definition block 444) and editing the received background mesh using the received one or more conformable sequences (e.g., per the edit block 450) to provide an edited mesh. In such an example, the method 410 may include populating the edited mesh with values of an implicit function via an interpolation procedure (e.g., per the implicit function interpolation block 462) based at least in part on receiving, as input, horizon geometry (e.g., per the input block 428). In such an example, the method 410 may include outputting a mesh that is or may be “split” into multiple volumes along one or more unconformities (see, e.g., the formations 320, 330 and 340 of FIG. 3). For example, the method 410 may include outputting a mesh (e.g., per the mesh output block 482). In turn, a model of a geologic environment may be constructed at least in part using such a mesh.

As an example, a method may be implemented that can create a model (e.g., a multidimensional spatial model) of a faulted stratigraphic sequence (e.g., faulted geological layers). Such a method may include creating a model that represents one or more unconformities, for example, where an unconformity may be a domain boundary that separates younger rock from older rock (e.g., consider a gap in a geological time record). As an example, a method may create a model for use in modeling structures, phenomena, etc. in one or more dimensions. As an example, a model may be suited for modeling structures, phenomena, etc. with respect to time (e.g., a time dimension, whether forward, backward or both). As an example, a method that includes performing one or more numerical techniques may use a model, for example, to discretize a geologic environment (e.g., in one or more dimensions) and to formulate sets of equations that correspond to at least a portion of the discretized geologic environment. For example, a model may include nodes, a grid defined by nodes, cells (e.g., consider two-dimensional cells and three-dimensional cells), etc.

As an example, a method such as the method 410 may account for real geometrical input, for example, without necessarily having to model or interpret eroded or non-deposited parts of layers, or eroded parts of faults. As an example, a method may include constructing a geological model in the form of a mesh or of a set of meshes, such that the model is watertight, for example, where one or more faults, conformable layers and unconformities may be represented by meshes (e.g., optionally resulting from splitting of a mesh) that have contacts (i.e. no geometrical gaps or overlaps) with each other. As an example, a method may include accounting for fault activity, for example, where faults may be eroded by some conformable sequences while introducing a discontinuity in younger sequences, in a geologically consistent manner. As an example, a method may be tolerant to geometrical inaccuracies in the interpretation of such eroded faults, and may produce geologically meaningful results even if the fault interpretation is going past the erosion surface that should be truncating it.

As an example, a method may include modeling simultaneously (e.g., representing by a single implicit function on a volume mesh), horizons that belong to a particular conformal sequence (e.g., including one or more sequence boundaries where one or more may be an unconformity). For example, referring to the example formations 320, 330 and 340 of FIG. 3, a method may include modeling successively each of the conformable sequences subject to a sequence boundary (e.g., or boundaries) that may be an unconformity (e.g., an erosion, a baselap, a discontinuity, etc.), for example, by representing conformal sequences by one or several implicit functions defined on separate (e.g., topologically disconnected) elements of a background mesh. Such an approach may provide for reliable and accurate modeling of conformable or non-conformable horizons, for example, which may at times be defined by sparse data (e.g., consider well tops data).

Referring again to the method 410 of FIG. 4, examples of Options A and B are shown with respect to the fault geometry input block 422. For Option A, the input block 422 may provide input to the build block 442 for use in building a background mesh; whereas, for Option B, the fault geometry input block 422 may provide input to the edit block 450. For Option A, as an example, a background mesh may be built by the build block 442 such that the background mesh is constrained, at least in part, by geometry of a fault or faults. For Option B, as an example, a background mesh may be unconstrained by geometry of a fault or faults while editing per the edit block 450 takes into account geometry of a fault or faults.

The method 410 of FIG. 4 may be referred to as an implicit modeling technique as it includes using one or more implicit functions. As an example, such a method can include representing geological horizons in three-dimensions using specific iso-surfaces of a scalar property field (e.g., an implicit function) defined on a three-dimensional background mesh. In such an example, continuity of the scalar field property may be governed by continuity of the background mesh.

As an example, a method can include building a background mesh suitable for interpolating an implicit function, identifying a set of conformable sequences from the geological type of stratigraphic horizons, and editing the background mesh on which the interpolation is performed for processing of a first conformable sequence or between processing of two successive conformable sequences. As to such editing, it may include creating sub-volumes in the background mesh by subdividing it by previously interpolated sequence boundaries (see, e.g., the subdivision block 452 of FIG. 4), identifying sub-volumes corresponding to a “current” conformable sequence (see, e.g., the identification block 454 of FIG. 4) and restricting further interpolation and iso-surface extraction processes to the identified sub-volumes and, for example, managing fault activity in one or more of the identified sub-volumes (see. e.g., the (de)activate (in)activate block 456 of FIG. 4), for example, by introducing and/or removing one or more internal discontinuities in the background mesh.

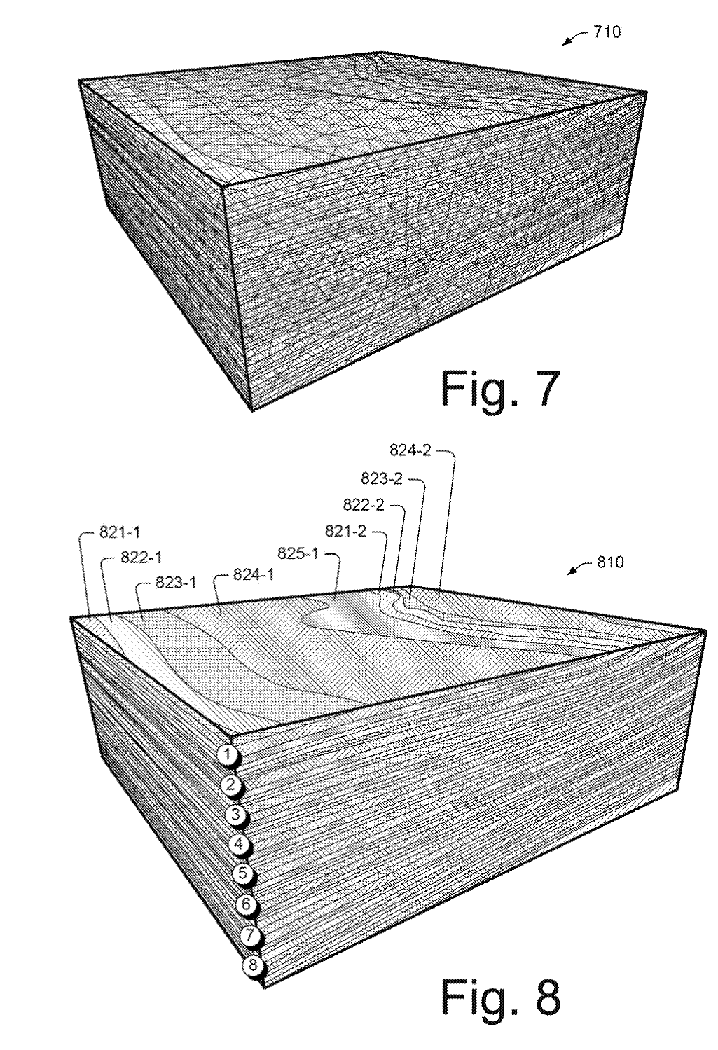

As to processing one or more implicit functions, a method can include interpolating one or more implicit functions on a “conformable sequence per conformable sequence” basis, for example, optionally one conformable sequence at a time (see. e.g., the example meshes of FIGS. 7 and 8).

In the example of FIG. 4, the method 410 includes a return block 464 whereby results from the implicit function interpolation block 462 may be provided to the edit block 450 to perform one or more additional edits to the edited background mesh. As an example, a loop may exist between the edit block 450 and the implicit function interpolation block 462, for example, where various actions may be repeated to process a stratigraphic pile (e.g., for modeling the stratigraphic pile). As an example, an iso-value of a previously interpolated implicit function that corresponds to an unconformity (e.g., a sequence boundary) may be used as input to sub-divide block 452, As mentioned, the method 410 can include output 480, for example, which may output a mesh (e.g., or meshes) per the mesh output block 482. As an example, a mesh (e.g., or meshes) may be considered a model of a geologic environment.

The method 410 is shown in FIG. 4 in association with various computer-readable media (CRM) blocks 443, 445, 451, 463, 465 and 483. Such blocks generally include instructions suitable for execution by one or more processors (or cores) to instruct a computing device or system to perform one or more actions. While various blocks are shown, a single medium may be configured with instructions to allow for, at least in part, performance of various actions of the method 410. As an example, a computer-readable medium (CRM) may be a computer-readable storage medium. As an example, the blocks 443. 445, 451, 463, 465 and 483 may be provided as one or more modules, for example, such as the one or more modules 407 of the system 401 of FIG. 4.

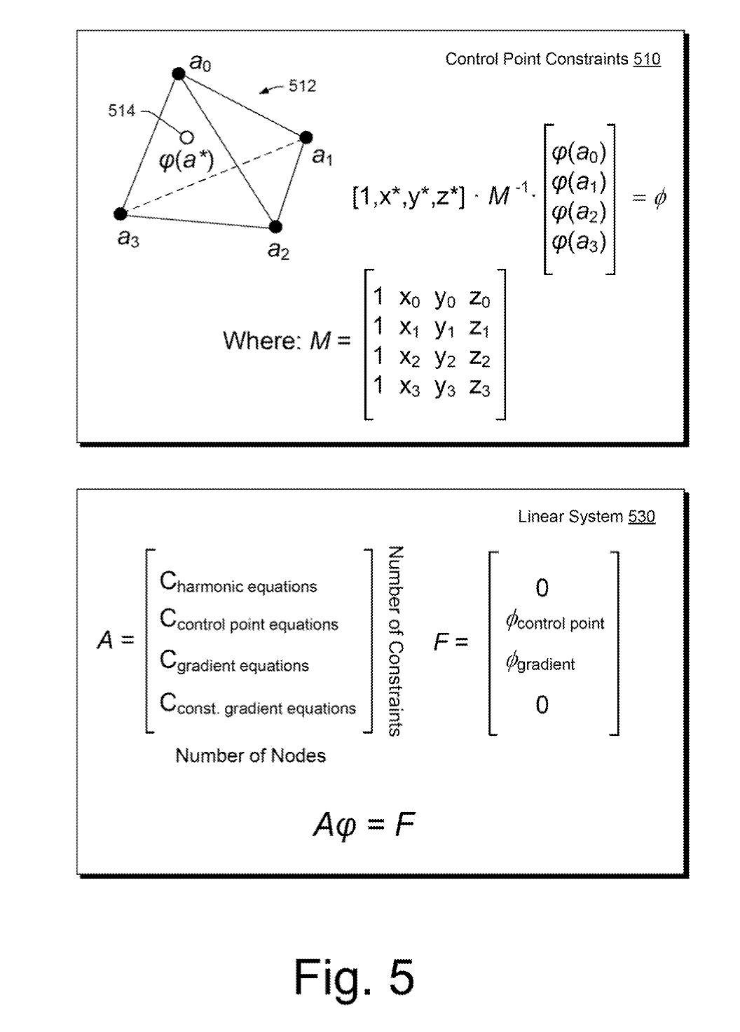

FIG. 5 shows an example of a control point constraints formulation 510 with respect to a tetrahedral cell 512 (e.g., a volumetric element) that includes a control point 514 and an example of a linear system formulation 530. As an example, an implicit function may be a scalar field. As an example, an implicit function may be represented as a property or an attribute, for example, for a volume (e.g., a volume of interest). As an example, the aforementioned PETREL® framework may include a volume attribute that includes spatially defined values that represent values of an implicit function.

As an example, a function “F” may be defined for coordinates (x, y, z) and equated with an implicit function denoted φ. As to constraint values, the function F may be such that each input horizon surface “I” corresponds to a known constant value hᵢ of φ. For example, FIG. 5 shows nodes (e.g., vertices) of the cell 512 as including a₀, a₁, a₂ and a₃ as well as corresponding values of φ (see column vector). As to the values hᵢ of φ, if a horizon I is younger than horizon J, then hᵢ>hⱼ and, if one denotes T_ij* as an average thickness between horizons I and J, then (hₖ˜hᵢ)/(hᵢ−hᵢ)˜T_ik*/Tij* , for which a method can include estimating values of T_ij* before an interpolation is performed. Note that the method may accept lower values hᵢ of φ for younger horizons, for example, a constraint being that, within each conformal sequence, the values hᵢ of φ vary monotonously with respect to the age of the horizons. As an example, this may be a single constraint.

As to interpolation of “F”, as an example, φ may be interpolated on nodes of a background mesh (e.g., a triangulated surface in 2D, a tetrahedral mesh in 3D, a regular structured grid, quad/octrees, etc.) according to several constraints that may be honored in a least squares sense. In such an example, as the background mesh may be discontinuous along faults, interpolation may be discontinuous as well; noting that “regularization constraints” may be included, for example, for constraining smoothness of interpolated values.

As an example, a method can include interpolating an implicit function on a vertical (2D) cross-section through a model where, for example, the interpolating includes constraining the interpolation by dip information. For example, consider a method that includes constraining an interpolation by apparent dip of one or more horizons of a section (e.g., seismic horizons of a 2D cross-section).

As an example, a method may include using fuzzy control point constraints. For example, consider a location of interpretation points, hᵢ of φ (see, e.g. point a* in FIG. 5). As an example, an interpretation point may be located at a location other than that of a node of a mesh onto which an interpolation is performed, for example, as a numerical constraint may be expressed as a linear combination of values of φ at nodes of a mesh element (e.g. a tetrahedron, tetrahedral cell, etc.) that includes the interpretation point (e.g., coefficients of a sum being barycentric coordinates of the interpretation point within the element or cell).

For example, for an interpretation point p of a horizon I located inside a tetrahedron which includes vertices are a₀, a₁, a₂ and a₃ and which barycentric coordinates are b₀, b₁, b₂ and b₃ (e.g., such that the sum of the barycentric coordinates is approximately equal to 1) in the tetrahedron, an equation may be formulated as follows:

b₀φ(a₀)+b₁φ(a₁)+b₂φ(a₂)+b₃φ(a₃)=hᵢ;

where unknowns in the equation are φ(a₀), φ(a₁), φ(a₂) and φ(a₃). For example, refer to the control point φ(a*), labeled 514 in the cell 512 of the control point constraints formulation 510 of FIG. 5, with corresponding coordinates (x*, y*, z*); noting a matrix “M” for coordinates of the nodes or vertices for a₀, a₁, a₂ and a₃. (e.g., x₀, y₀, z₀ to x₃, y₃, z₃).

As an example, the number of such constraints of the foregoing type may be based on the number of interpretation points where, for example, interpretation points may be decimated interpretation for improving performance.

As mentioned, a process can include various regularization constraints, for example, for constraining smoothness of interpolated values, of various orders (e.g., constraining smoothness of φ or of its gradient ∇φ), which may be combined through a weighted least squares scheme.

As an example, a method can include constraining the gradient ∇φ in a mesh element (e.g. a tetrahedron, a tetrahedral cell, etc.) to take a (weighted) arithmetic average of values of the gradients of φ with respect to its (topological) neighbors. As an example, one or more weighting schemes may be applied (e.g. by volume of an element) and one or more definitions of a topological neighborhood (e.g., by face adjacency) may be considered. As an example, two geometrically “touching” mesh elements that are located on different sides of a fault may be deemed not topological neighbors, for example, as a mesh may be “unsewn” along fault surfaces (e.g., to define a set of elements or a mesh on one side of the fault and another set of elements or a mesh on the other side of the fault).

As an example, within a mesh, if one considers a mesh element mᵢ that has n neighbors mⱼ (e.g., for a tetrahedron), one may formulate an equation of the regularization constraint as follows:

$$∇ ϕ ( {m}_{i} ) = \frac{1}{n} {\sum }_{j = 1}^{n} ∇ ϕ ( {m}_{j} )$$

In such an example of a regularization constraint, where solutions for which iso-values of the implicit function would form a “flat layer cake” or “nesting balls” geometries may be considered “perfectly smooth” (i.e. not violating the regularization constraint), it may be that a first one is targeted.

As an example, one or more constraints may be incorporated into a system in linear form. For example, hard constraints may be provided on nodes of a mesh (e.g., a control node). In such an example, data may be from force values at the location of well tops. As an example, a control gradient, or control gradient orientation, approach may be implemented to impose dip constraints.

Referring again to FIG. 5, the example linear system formulation 530 includes various types of constraints. For example, a formulation may include harmonic equation constraints, control point equation constraints (see, e.g., the control point constraints formulation 510), gradient equation constraints, constant gradient equation constraints, etc. As shown in FIG. 5, a matrix A may include a column for each node and a row for each constraint. Such a matrix may be multiplied by a column vector such as the column vector φ(aᵢ) (e.g., or φ), for example, where the index “i” corresponds to a number of nodes, vertices, etc. for a mesh (e.g., a double index may be used, for example, aᵢⱼ, where j represents an element or cell index). As shown in the example of FIG. 5, the product of A and the vector φ may be equated to a column vector F (e.g., including non-zero entries where appropriate, for example, consider φ_{control point} and φ_{gradient}).

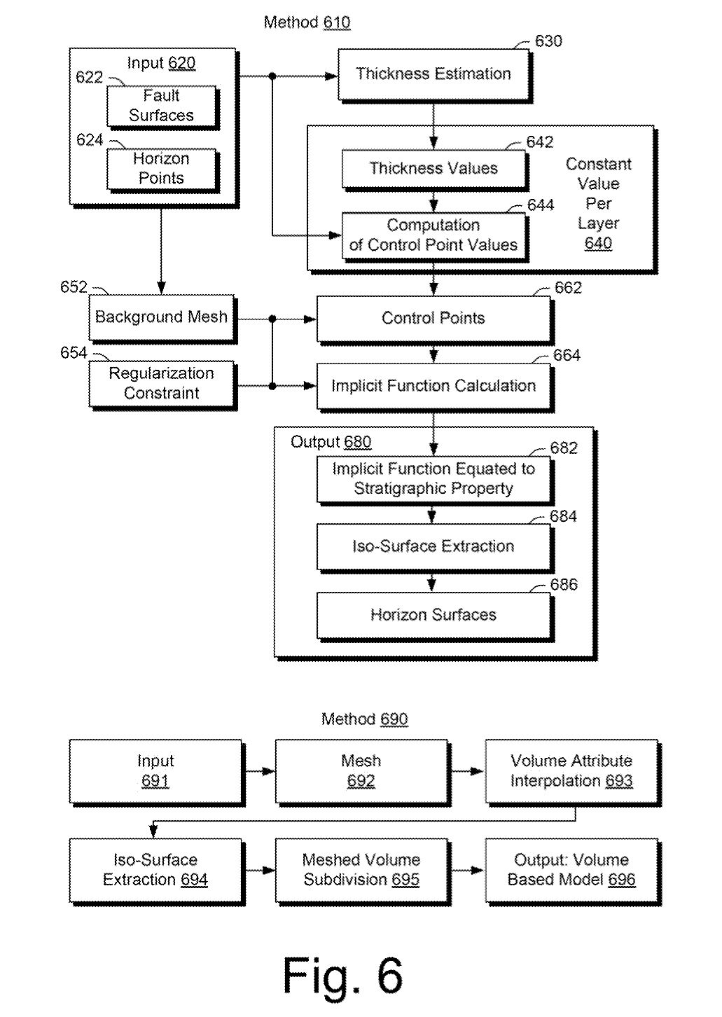

FIG. 6 shows a block diagram of an example of a method 610 that includes an input block 620 and output block 680, for example, to output an implicit function equated to a stratigraphic property per a block 682. As to the input block 620, it may include a fault surfaces input block 622 and a horizon points input block 624. As shown in the example of FIG. 6, the input block 620 may provide input to a thickness estimation block 630, a layer block 640 and a background mesh block 652.

As to the layer block 640, it can include a thickness values block 642 for determining or receiving thickness values (e.g., based on or from the thickness estimation block 630) and a computation block 644 for computing control point values (see, e.g., the formulations 510 and 530 of FIG. 5). As shown, the layer block 640 can output control points to a control points block 662, which may be defined with respect to a mesh provided by the background mesh block 652. As an example, the control points of the control points block 662 may account for one or more regularization constraints per a regularization constraint block 654.

As an example, given control point values for layers definable with respect to a mesh and subject to one or more constraints, a method can include calculating values of an implicit function (e.g., or implicit functions). As shown in the example of FIG. 6, an implicit function calculation block 662 can receive control points and one or more constraints defined with respect to a mesh (e.g., elements, cells, nodes, vertices, etc.) and, in turn, calculate values for one or more implicit functions.

As to the output block 680, given calculated values for one or more implicit functions, these may be associated with, for example, a stratigraphic property per the block 682. As an example, one or more iso-surfaces may be extracted based at least in part on the values of the stratigraphic property per an iso-surface extraction block 684, for example, where one or more of the extracted iso-surfaces may be defined to be a horizon surface (e.g., or horizon surfaces) per a horizon surface block 686.

FIG. 6 also shows an example of a method 690 for outputting a volume based model (e.g., a model constructed from a subdivision of a volume of interest in sub-volumes representing stratigraphic layers, fault blocks or segments, etc.). As shown, the method 690 includes an input block 691 for inputting information (e.g., sealed fault framework information, horizon interpretation information, etc.), a mesh block 692 for providing or constructing a mesh, a volume attribute interpolation block 693 for interpolating values (e.g., using one or more implicit functions), an iso-surface extraction block 694 for extracting one or more iso-surfaces (e.g., based at least in part on the interpolated values), a subdivision block 695 for subdividing a meshed volume (e.g., based at least in part on one or more of the one or more extracted iso-surfaces) and an output block 696 for outputting a volume based model (e.g., based at least in part on one or more portions of a subdivided meshed volume).

As an example, the input block 691 may include one or more features of the input block 620 of the method 610, the mesh block 692 may include one or more features of the mesh block 652 of the method 610, the volume attribute interpolation block 693 may include one or more features of the implicit function calculation block 664 and/or the stratigraphic property block 682 of the method 610, the iso-surface extraction block 694 may include one or more features of the iso-surface extraction block 684 of the method 610, the subdivision block 695 may include subdividing a meshed volume using one or more horizon surfaces per the horizon surfaces block 686 of the method 610 and the output block 696 may include outputting a volume based model based at least in part on one or more outputs of the output block 680 of the method 610.

As explained with respect to the method 410 of FIG. 4, an implicit function may be provided for performing, for example, interpolation. As an example, an implicit modeling approach can include representing surfaces as iso-values of a volume attribute (e.g., of an implicit function). As an example, such a volume attribute may be referred to as being a “thickness proportion” (e.g., volumetrically filling in space). For example, an implicit function may correspond to the stratigraphic age of formations and, for example, such an implicit function may be embedded and interpolated in a volumetrically filling tetrahedral mesh (e.g., structured, unstructured, etc.).

As an example, a method can include building a tetrahedral mesh for carrying and interpolating an implicit function. As an example, a 3D boundary-constrained Delaunay mesh generator may be implemented, for example, with constraints such as constraints based on faults affecting considered horizons where such faults may be accounted for as internal boundaries during mesh generation, for example, where some border faces of tetrahedra may match fault geometries in a resulting mesh. As an implicit function may be defined and interpolated on nodes of a tetrahedral mesh, density of the mesh, and therefore the spatial resolution of the implicit function, may be controlled, for example, to include a higher density within a shell at, proximate to or around various data and/or faults (e.g., to maximize degree of freedom of an interpolation at or near various data and/or faults). As an example, a mesh adaptation process may include producing tetrahedra that have a vertical resolution higher than their areal resolution (e.g., to better capture thickness variations in layering). As an example, a resulting mesh (e.g., a built mesh) may be unstructured.

As an example, a method can include interpolating values of an implicit function on nodes of a tetrahedral mesh. As an example, an interpolation process may include using a linear least squares formulation, which may tend to minimize misfit between interpretation data and interpolated surfaces and to minimize variations of dip and thickness of layers.

As an example, a method can include generating surfaces representing individual implicitly modeled horizons. In such an example, as the specific value of the implicit function associated to each of the individual horizons may be known, a method may include using an iso-surfacing algorithm. As an example, resolution of a resulting surface or surfaces may be higher or approximately equal to a local resolution of a tetrahedral mesh around sample points (e.g., which may be user-controllable).

As an example, a method may include a volume based modeling approach that generates a consistent zone model (e.g., a model of interpreted geological layers). For example, such a zone model may include an individual geological layer that may be seen as an interval of values of an implicit function. In such an example, given its value of the implicit function, a method may determine to which layer an arbitrary point belongs, in particular where such arbitrary points correspond to nodes of a mesh supporting the implicit function.

As an example, edges of a tetrahedral mesh may intersect limits of geological layers. In such an example, construction of such intersection points may have been computed where they correspond to nodes of triangulated surfaces representing horizons. Accordingly, zones may be built by cutting edges of the tetrahedral mesh by some iso-surfaces of the implicit function.

As an example, a method can include cutting a volume to produce zones that are sets of tetrahedra. As an example, a method can include cutting volume borders to produce zones that are sets of triangulated patches. As to the latter, it may include cutting volume borders by iso-contours. As noted, one or more implicit functions may be formulated for determination of iso-surfaces and/or iso-contours that do not intersect one another other.

As an example, a volume based modeling approach may be less sensitive to complexity of a fault network and may provide conformable horizons belonging to a common conformable sequence (e.g., which may be modeled simultaneously). As to the latter, by using an implicit approach (e.g., by representing sets of conformable horizons by several iso-values of a common implicit attribute), the approach may avoid crossing of conformable horizons.

As an example, a volume based modeling approach may provide for conformable horizons that constrain geometry of other conformable horizons that belong to a common sequence, which itself may be constrained by geometry. As an example, a volume based modeling approach may be applied in scenarios where data are sparse, for example, consider data from well tops. 2D sections, etc. As an example, one or more surfaces may be modeled using seismic data and, for example, globally adjusted using well top data.

As an example, a volume based modeling approach may include outputting geometry of a horizon as well as volume attribute values, which may be defined within a volume of interest and, for example, represent a stratigraphic age, or relative chronostratigraphic age, of a formation (or formations).

As an example, the method 410 of FIG. 4 may include outputting one or more models (e.g., a mesh or meshes, etc.) that account for various features of a geologic environment, for example, where the output model or models is volume filling (e.g., “watertight” or “sealed”).

As an example, a method may be implemented to create a reservoir model on a “conformable sequence per conformable sequence” basis, for example, where surfaces belonging to a common conformable sequence may be interpolated simultaneously. As an example, a method can include iteratively editing topology of a volume mesh, for example, to control extent of the volume in which an interpolation is performed and continuity of an interpolated implicit function. As an example, a method may include producing layering that is consistent with a geological style of deposition in one or more eroded areas.

As an example, a method can include building a background mesh, for example, where the background volume mesh covers a volume of interest (VOI), which itself may be of a size sufficient to include horizons to be modeled.

FIG. 7 shows an example of a mesh 710 that may be volumetrically filled by, for example, tetrahedra. In the example of FIG. 7, the mesh 710 is also shown along with volume attribute values. In the example of FIG. 7, the volume attribute values may be displayed or represented with respect to a periodic color scale, for example, where the volume attribute or “property” may be monotonously increasing (e.g., corresponding to values of a monotonic implicit function). For example, each “period” of the periodic scale may correspond to a layer in a series of layers defined by input horizons. In such an example, an individual horizon may be conformable to another individual horizon within a common sequence.

FIG. 8 shows a volume 810 that corresponds to the mesh 710 of FIG. 7, however, without lines indicating mesh elements (e.g., mesh cells, etc.). In the example of FIG. 8, eight portions (portions 1 to 8) are shown as an example for purposes of explanation. For example, within these portions, a periodic scale may be repeated as indicated by black and white hatchings: 821-1, 822-1, 823-1, 824-1, 825-1, 821-2, 822-2, 822-3, 824-2, etc. As mentioned, the scale may represent values of an implicit function.

Referring again to FIG. 7, the tetrahedral background mesh 710 also shows an implicit function represented by a periodic scale (e.g., whether black and white, color, etc.) that may be interpolated within the background mesh. As mentioned, FIG. 8 shows the volume 810 without the mesh lines to more dearly illustrate an example of a periodic scale for an implicit function.

As an example, a method may include building a mesh that includes subsets of its facets that match (e.g., in a general sense) elements of the mesh representing one or more faults. In such an example, the facets may be approximating, in the background mesh, geometry of a fault network. As an example, a mesh may include elements with shape and size that are specified to be suitable for an interpolation process (e.g., shape, size, etc. may be specified depending on one or more characteristics of an interpolation process).

As an example, a mesh may be considered an initial mesh (e.g., or other early stage mesh) that may not include one or more internal borders, for example, that represent one or more discontinuities.

As an example, a method can include identifying one or more conformable sequences. In such an example, an identification process may include identifying a set of conformable sequences from a geological type of stratigraphic horizons, for example, provided by an operator of the system. As an example, consider one or more of the definitions provided with respect to FIG. 3 where: (a) an erosion may be an unconformity that is conformable to one or more horizons immediately younger (e.g., without gaps in the geological record) and not conformable to one or more older horizons; (b) a baselap may be an unconformity that is conformable to one or more horizons immediately older (e.g., without gaps in the geological record) and not conformable to one or more younger horizons; and (c) a discontinuity may be an unconformity that is neither conformable to one or more older horizons nor to one or more younger ones. As an example, a conformable horizon may be assumed to be conformable to at least an adjacent younger horizon and at least an adjacent older horizon.

Provided with definitions for a given stratigraphic sequence that includes conformable horizons and unconformities, it may be possible to divide the sequence into subsets of conformable sequences, for example, where an individual horizon (e.g., conformable or unconformity) belongs to a single conformable sequence. For example, consider the following rules: (a) an erosion is the oldest horizon to be modeled in the conformable sequence it belongs to; (b) a baselap is the youngest horizon to be modeled in the conformable sequence it belongs to; and (c) a discontinuity is modeled alone in its “own” conformable sequence, which may be, in such a case, a conformable sequence that is degenerated to a single surface.

Through use of such rules, a produced conformable sequence may include a set of horizons that are conformable to one another, for example, meaning that they do not have any contact with one another and do not intersect one another. In such an example, an individual conformable sequence may be modeled with a single implicit function. As an example, a one-to-one correspondence may exist between conformable sequences and implicit functions.

As an example, a method can include editing a mesh (e.g., a background mesh). For example, an editing process may prepare a mesh for interpolation of an implicit function for modeling a given conformable sequence in the mesh. As an example, consider a sub-volume process that can create sub-volumes within a meshed volume of interest (VOI). As an example, sub-volumes may be first created from sub-volumes of a background mesh used to model a prior conformable sequence; noting that where a conformable sequence is a first conformable sequence, such a process may, by definition, not have a prior conformable sequence and may be created directly. As an example, a sub-volume process may include cutting sub-volumes according to one or more unconformities that may bound a conformable sequence previously modeled.

A sub-volume process may be performed, for example, in a manner that avoids numerical instabilities where a feature may be an iso-surface of a scalar property field defined within considered sub-volumes. In such an example, geometrical intersections between mesh elements of the feature (e.g., which may be triangles or other shaped faces) and the mesh elements of the sub-volumes (e.g., which may be tetrahedra or other volumes), may be, for example, one of two kinds: (i) a node of a triangle lying on an edge of a tetrahedron; or (ii) a node of a triangle being collocated with a node of a tetrahedron. Such an approach may, for example, facilitate computation of one or more geometrical intersections.

As an example, an identification process may include identifying one or more sub-volumes as corresponding to a conformable sequence. For example, where a previously modeled unconformity is modeled through a volume of interest and includes a maximum areal extension, it may intersect the volume of interest in a manner that divides the volume of interest into sub-volumes such as, for example, two subsets of new sub-volumes. As an example, one subset of new sub-volumes may be for a sequence older than an unconformity while another subset of new sub-volumes may be for a sequence younger than the unconformity.

As an example, a method may include computing relative ages by taking an average value of an implicit function having been used to model an unconformity in a sub-volume and comparing it with a value of an iso-surface that represents the unconformity. For example, an iso-surface may be defined along a scale that corresponds to age. As an example, depending on order with which conformable sequences are modeled (e.g., from younger to older or from older to younger), one of two subsets of new sub-volumes may be selected and considered for processing a next conformable sequence. As an example, a periodic scale may be implemented to facilitate visualization of an implicit function (e.g. with respect to one or more features in a sequence).

As to interpolation of an implicit function corresponding to a conformable sequence, as an example, its distribution may be discontinuous across one or more internal borders of a background mesh and continuous elsewhere (see, e.g., FIGS. 7 and 8). As an example, interpolation may be performed in one or more sub-volumes of a background mesh that have been created and identified as corresponding to a “current” conformable sequence. As an example, data points that included in such one or more sub-volumes may be taken into account to constrain an interpolation of an implicit function. As an example, once an interpolation process has been performed to provide values for an implicit function, implicit horizons of the “current” conformable sequence may be transformed into explicit surfaces using one or more iso-surfacing algorithms.

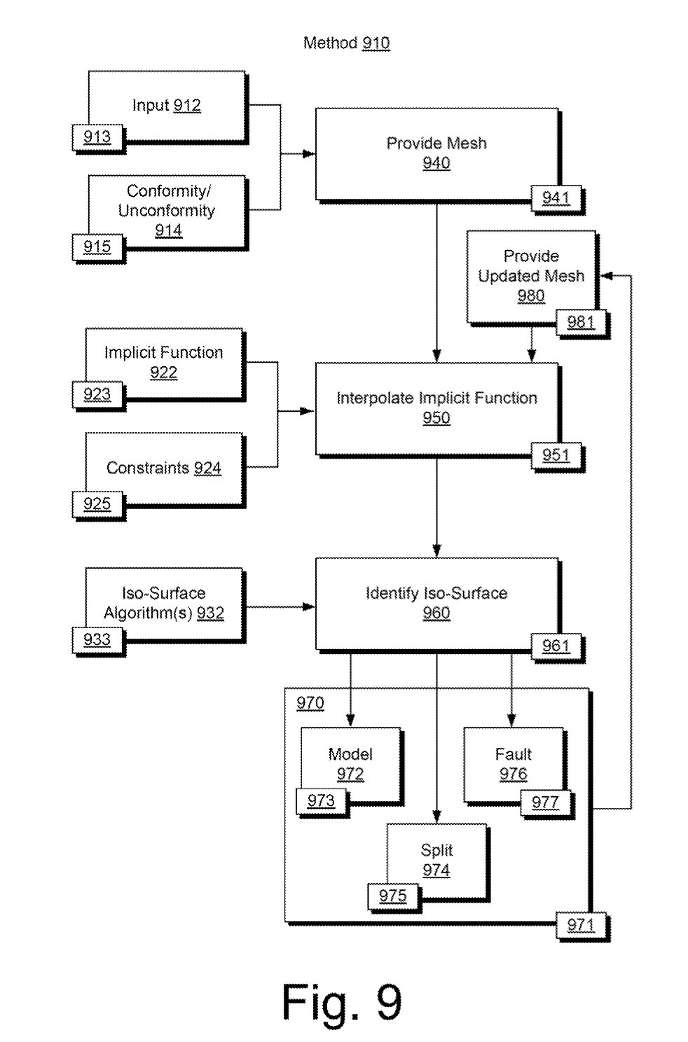

FIG. 9 shows an example of a method 910 that includes a provision block 940 for providing a mesh of a geologic environment that includes conformable sequences and an unconformity (or unconformities); an interpolation block 950 for interpolating an implicit function defined with respect to the mesh to provide values for the implicit function; and an identification block 960 for identifying an iso-surface based on a portion of the values where the iso-surface represents the unconformity, for example, as residing between two of the conformable sequences.

As an example, the provision block 940 may include providing the mesh, receiving the mesh, building the mesh, editing a mesh, etc. based at least in part on receiving input from an input block 912 and input from a conformity/unconformity block 914. As an example, the conformity/unconformity block 914 may provide for defining one or more unconformities in a mesh, for example, with respect to one or more conformal sequences. As an example, the conformity/unconformity block 914 may provide data associated with an unconformity, for example, where the data is represented as values, points. etc. in a mesh.

As an example, the interpolation block 950 may include receiving one or more implicit functions per an implicit function block 922 and include receiving one or more constraints per a constraints block 924. As an example, an implicit function (or implicit functions) may be constrained by one or more constraints. As an example, where a mesh includes nodes, one or more constraints may be defined with respect to a portion of those nodes. In such an example, a linear system of equations may be formulated and solved, for example, as part of an interpolation process to provide values for an implicit function (e.g., or implicit functions).

As an example, the identification block 960 may include receiving one or more algorithms, for example, for forming iso-surfaces given values within a region or regions such as a region or regions of a mesh. For example, an algorithm may receive as input values associated with an implicit function and then define iso-surfaces for at least some of those values. As an example, an iso-surface may correspond to a horizon, an unconformity, etc. As an example, a series of iso-surfaces may correspond to a conformable sequence, for example, where the conformable sequence is at least partially bound by an unconformity, which may be represented itself as an iso-surface.

In the example of FIG. 9, the method 910 may include a block 970 for performing one or more additional actions. For example, a model block 972 may provide for outputting a model based at least in part on the identified iso-surface where such a model may be used for modeling one or more physical phenomena associated with a geologic environment (e.g., including one or more processes applied to the environment such as injection, production, etc.). As an example, the block 970 may include a splitting block 974 for splitting or sub-dividing a mesh based at least in part on an identified iso-surface. For example, where the iso-surface corresponds to an unconformity, a mesh may be split into meshes based at least in part on that iso-surface (e.g., to form a first mesh and a second mesh where the unconformity may belong to one of the first mesh or the second mesh). As an example, the block 970 may include a fault block 976 for introducing one or more faults, for activation of one or more faults, for deactivation of one or more faults, etc.

As an example, the method 910 may include a provision block 980 for providing an updated mesh (e.g., receiving an update mesh via performance of a process or processes). For example, where splitting occurs per the splitting block 974, a mesh may be updated and provided to the interpolation block 950 for further processing (e.g., the interpolation block 950 may receive an updated mesh or updates meshes). As an example, the conformity/unconformity block 914 may provide input for updating a mesh. For example, where a mesh has been split into a first mesh and a second mesh according to a first unconformity, one of the first mesh and the second mesh may be further processed, for example, using data, etc. associated with another unconformity. In the example of FIG. 9, the method 910 may perform iteratively, for example, by looping to edit a mesh (e.g., whether an initial provided mesh, a subsequent mesh resulting from splitting, etc.) and to perform interpolation of one or more implicit functions with respect to an edited mesh.

The method 910 is shown in FIG. 9 in association with various computer-readable media (CRM) blocks 913, 915, 923, 925, 933, 941.951.961. 971, 973, 975, 977 and 981. Such blocks generally include instructions suitable for execution by one or more processors (or cores) to instruct a computing device or system to perform one or more actions. While various blocks are shown, a single medium may be configured with instructions to allow for, at least in part, performance of various actions of the method 910. As an example, a computer-readable medium (CRM) may be a computer-readable storage medium. As an example, the blocks 913, 915, 923, 925, 933, 941, 951, 961, 971, 973, 975, 977 and 981 may be provided as one or more modules, for example, such as the one or more modules 407 of the system 401 of FIG. 4.

As an example, given values of an implicit function at nodes of a coarse scale mesh and given nodes of a finer scale mesh, a method may include interpolating the implicit function to provide interpolated values at the nodes of the finer scale mesh. However, such implicit function values may be merely interpolated values, for example, one or more values based on additional information. Where additional information is available, for example, at a resolution corresponding to the finer scale mesh, such information may be used to formulate constraints. Such constraints may be included in a system of equations such that residual values may be computed at nodes of the finer scale mesh, for example, where the residual values may account for “error” (e.g., as to how the interpolated values may fail to adhere to the constraints). In such an example, the resolution of the implicit function values of the coarse mesh may be improved (e.g., adjusted, alerted, etc.) by adding the interpolated values at the nodes of the finer mesh and the residual values at the nodes of the finer mesh. Such an approach may thereby generate implicit function values at nodes of the finer mesh (e.g., where the values account for the additional information). Further, given such values, interpolation may be performed to interpolate the values between nodes of the finer mesh (e.g., within elements of the finer mesh, as defined by nodes of the finer mesh).

As an example, a method can include generating a fine scale implicit function (e.g., representing relative geological time at a scale of a seismic signal) using a coarse scale implicit function (e.g., generated using a coarse scale mesh, which may be an unstructured mesh) and a fine scale residual (e.g., determined via solution of a system of equations with applied constraints using a finer scale mesh).

As an example, unknowns of a linear system of equations may be values of a residual “r” at nodes of a fine scale mesh where implicit function values at nodes of a coarser scale mesh are fixed values. For example, given implicit function values at the nodes of the coarser scale mesh and additional information (e.g., seismic data) at a finer scale, a constrained system of equations may be solved to provide values of the residual “r” at nodes of a fine scale mesh.

As an example, implicit function values at nodes of a fine scale mesh (e.g., without contribution from a residual) may be estimated via interpolation using values at nodes of the coarse scale mesh (e.g., consider linear interpolation). For example, where a coarse scale mesh includes tetrahedral volume elements defined by nodes (e.g., four nodes per tetrahedron), implicit function values at nodes of a fine scale mesh within a tetrahedron may be estimated by linear interpolation of implicit function values at nodes of the coarse scale mesh. Further, by solving a linear system of equations, values for a residual may be obtained for nodes of the fine scale mesh.

As an example, where estimated values are available for an implicit function at nodes of a fine scale mesh (e.g., via interpolation of values of a coarse scale mesh) and where residual values are available at the nodes of the fine scale mesh (e.g., via solving a linear system of equations), implicit function values at the nodes of the fine scale mesh may be determined by adding the estimated values and the residual values (e.g., adding interpolated values and residual values at nodes of the fine scale mesh).

As an example, a method may include determining φ_fine (implicit function values at nodes of a fine mesh) by adding values of φ_main (interpolated implicit function values of a coarse mesh at nodes of the fine mesh) and values of a residual “r” at the nodes of a fine mesh.

As an example, a set of confidence factors may represent uncertainty of attribute values (e.g., a value linked with quality of a seismic signal at a spatial location). In such an example, the set of confidence factors may be accounted for during solving a system of equations to provide a residual “r” (e.g., a residual at a fine mesh). For example, confidence factors may be translated into a set of coefficients that may be used to weight corresponding linear equations prior to resolution of a least squares system. As an example, where data have confidence factors below a threshold, such data may be ignored or discarded from a system of equations (e.g., consider a weight of zero).

As an example, an implicit function φ_main may be defined by values at nodes of a coarse mesh and by an interpolation operator (e.g. linear for a coarse mesh that may be a tetrahedralized filled volume) applied within a region of interest (e.g., a volume of interest, a surface, etc.) such that φ_main(x,y,z) may be estimated in the region of interest (e.g., including at locations of nodes of a finer mesh), for example, where spatial resolution (e.g., as to information) may be dependent on resolution of the coarse mesh.

As an example, an approach may consider a residual “r” to be defined by values at nodes of a fine mesh and by an interpolant (e.g. tri-linear for a fine mesh that may be a structured hexahedral 3D grid) in a region of interest (e.g., volume of interest, surface of interest, etc.) such that φ_fine=φ_main+r may be estimated within the region of interest (e.g., at nodes of a mesh, other points, etc.), for example, while being defined in part by values stored at nodes of a coarse mesh (e.g., the φ_main part) and partly by values stored at the nodes of the fine mesh (e.g., fine grid) plus respective interpolants.

As an example, a method may include estimating values of φ_main at nodes of a fine mesh, for example, to build a linear system of equations that can enable calculating residual values at such nodes. For example, a method may include interpolating implicit function values at nodes of a coarse mesh to provide interpolated implicit function values at nodes of a finer mesh (e.g., which may be considered an “intermediate” estimate of the implicit function at the nodes of the fine mesh); and formulating constraints based on data (e.g., fuzzy control point I fuzzy control gradient based at least in part on seismic data). In such an example, the method may further include solving equations to provide residual values or values based at least in part on a formulation that may include residual terms. Such a solution may provide an implicit function with a higher resolution than that associated with nodes of a coarse mesh.

As an example, a method may combine and/or interleave interpolating implicit function values and formulating constraints (e.g., based at least in part on data). As an example, a method may interpolate φ_main on some nodes of a fine mesh prior to building linear equations, for example, as φ_main(fine_node_j) may be estimated “on the fly” (e.g., provided the interpolant f such that φ_main(fine_node_j)=f{i=k . . . l} (φ_main(coarse_node_i)) is known. As an example, an interpolant may be a weighted sum. As an example, a method may include expressing r(fine_node_j) directly as a function of φ_main(coarse_node_i) {i=k . . . l} plus terms depending on fine scale constraints and a function, for example: r(fine_node_h) (i=m . . . n) (e.g., for unknowns for such a system).

As an example, additional information may be captured (e.g., represented) via a residual. For example, a method may include formulating an equation to include a residual, formulating a system of equations subject to constraints (e.g., based on data) and solving the system of equations for values of the residual where the residual represents an adjustment or alteration that may be made to an existing solution, for example, to increase the resolution of that existing solution.

As an example, a method may include defining a fine scale-interpolant (e.g., to interpolate residual values “r” in-between nodes of a fine mesh), for example, where values of φ_fine at the nodes of the fine mesh may be a final result of the method. As an example, a method may include an optional interpolation process, for example, that interpolates implicit function values between nodes/within elements of a fine mesh (e.g., linear, trilinear, etc.), which may be performed, for example, for purposes of display, another iteration, etc.

As an example, a method may include receiving implicit function values at nodes of a coarse mesh; receiving data, the data having a resolution finer than the coarse mesh (e.g., seismic data, attribute cube, etc.); defining a fine mesh, finer than the coarse mesh (e.g., based on the spatial resolution of the data); interpolating the implicit function values at nodes of the coarse mesh to provide interpolated implicit function values at nodes of the fine mesh (e.g., which may be considered an intermediate estimate of the implicit function at the nodes of the fine mesh); formulating constraints based on the data (e.g., fuzzy control point I fuzzy control gradient); formulating a linear system of equations based on the constraints and the interpolated implicit function values at the nodes of the fine mesh; solving the linear system of equations for residual values (“r”) at the nodes of the fine mesh (e.g., where the residual values carry the “new” information); and, to reach a final result, adding the residual values at the nodes of the fine mesh (“r”) and the interpolated implicit function values at the nodes of the fine mesh (e.g., the “intermediate” estimate). In such an example, φ_main may correspond to coarse mesh values at nodes of the coarse mesh and interpolated values at nodes of the fine mesh. In other words, as an example, the residual “r” and “φ_main” may have a common resolution; however, where resolution of “φ_main” is increased by interpolation (e.g., not information); whereas, data-based constraints add information such that the added information is “captured” by the residual.

As an example, a method may optionally include interpolating implicit function values (e.g., from a sum based on coarse mesh values and residual values) between nodes/within elements of a fine mesh (e.g., linear, tri-linear, etc.).

As an example, a seismic interpretation workflow may be performed to generate an interpreted version of a sub-surface environment. As an example, such a workflow may include one or more automated procedures, for example, that access data and interpret the data to enhance understanding of a sub-surface environment. For example, a workflow may include accessing seismic data (e.g., raw data, seismic attributes, etc.) and processing the seismic data in conjunction with one or more implicit functions associated with a mesh where the seismic data may provide for enhancing resolution of the one or more implicit functions. In such an example, the resolution of the seismic data may be spatially higher than the resolution of the mesh. For example, the seismic data may be “volumetric” and provided in the form of a data cube (e.g., seismic volume, attribute volume, seismic cube, attribute cube, etc.). As an example, a workflow may include at least one human interpretation processes and at least one automated interpretation process. In such an example, the human and/or the automated processes may be performed using seismic data.

As an example, seismic data may be acquired for a region in the form of traces. As an example, acquisition equipment may emit energy from a source (e.g., a transmitter) and receiving reflected energy via one or more sensors (e.g., receivers) strung along an inline direction, for example, according to a surface grid. In such an example, where a region includes layers, energy emitted by a transmitter of the acquisition equipment can reflect off the layers. Evidence of such reflections may be found in the acquired traces. As an example, energy received may be discretized by an analog-to-digital converter that operates at a sampling rate, for example, acquisition equipment may convert energy signals sensed by a sensor to digital samples at a rate of one sample per approximately 4 ms. Given a speed of sound in a medium or media, a sample rate may be converted to an approximate distance. For example, the speed of sound in rock may be of the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

As mentioned, seismic data may be acquired with reference to a surface grid (e.g., defined with respect to inline and crossline directions). For example, given grid blocks of about 40 meters by about 40 meters, a 40 km by 40 km field may include about one million traces. Such traces may be considered 3D seismic data where time approximates depth.

As mentioned, a mesh may have a resolution less than a resolution of seismic data or, for example, a mesh may include a region with a resolution less than a resolution of seismic data. As an example, where an implicit function exists for such a mesh, or a region thereof, a method may include processing seismic data to increase the resolution of the implicit function. For example, consider an implicit function that may have a resolution resulting from constraints placed on nodes of the mesh. In such an example, seismic data may provide for placement of constraints at a higher resolution than the nodes of the mesh. Such constraints may thereby increase resolution of values of an implicit function.

As an example, a method may include integrating human seismic interpretation, a seismic amplitude volume, and geological deposition rules while enforcing consistency of layer thicknesses and of fault displacements across a model. As an example, a method may provide for blending of two or more different inputs (e.g., simultaneously, sequentially, or within a multi-scaled iterative process).

As mentioned, a workflow may provide for building an implicit function, for example, based on structural interpretation and properties, for example, indicating sequences, type of layer boundaries (e.g. erosion, conformable, discontinuous, etc.), to generate a continuous three-dimensional function where, for example, samples in space have relative location in a geological depositional sequence. For example, an iso-value of an implicit function may represent a conformable depositional event that takes into account tectonic stages. In such an example (e.g., context), one may consider implicit function and stratigraphic function to be synonymous.

As an example, an implicit function may be generated from information provided by work of one or more interpreters (e.g. horizons, faults, bedding trends, fault displacement information, etc.), for example, in a manner without constraints being automatically extracted from a seismic image (e.g., images used by the one or more interpreter); rather than use of one or more constraints, being derived from seismic data (e.g., not being derived from visual interpretation), being used for calculation of an implicit function.

As an example, where an implicit function is directly derived from work of a visual seismic interpreter, resolution of the implicit function may be limited to the resolution of that work. In such an example, increasing the resolution of the implicit function may involve performing additional human interpretation at a finer scale, which may time consuming, demand substantial human resources, etc.

As an example, a method may include building a model using information derived through human visual interpretation and information derived through data processing. In such an example, the model may include one or more implicit functions.

As an example, a method may include manual implicit function building (hard controls) as well as automatically extracting of geological topography for one or more seismic reflectors (e.g., high resolution, consistent gradient of the implicit function based on the localized seismic frequency, etc.), removing isolated inconveniences (e.g., low resolution and no constrains when sparse data for the manual implicit function building; and sensitive to noise, difficult integration of the fault network, no control points for an automated process).

As an example, a method may include accounting for discrepancies between geometrical information extracted from well data (e.g., well tops) and from seismic interpretation while computing a coarse scale implicit function. For example, a method may allow for globally adjusting one or more seismic images in a manner such that a seismic image matches interpreted well data (e.g., throughout a volume of interest).

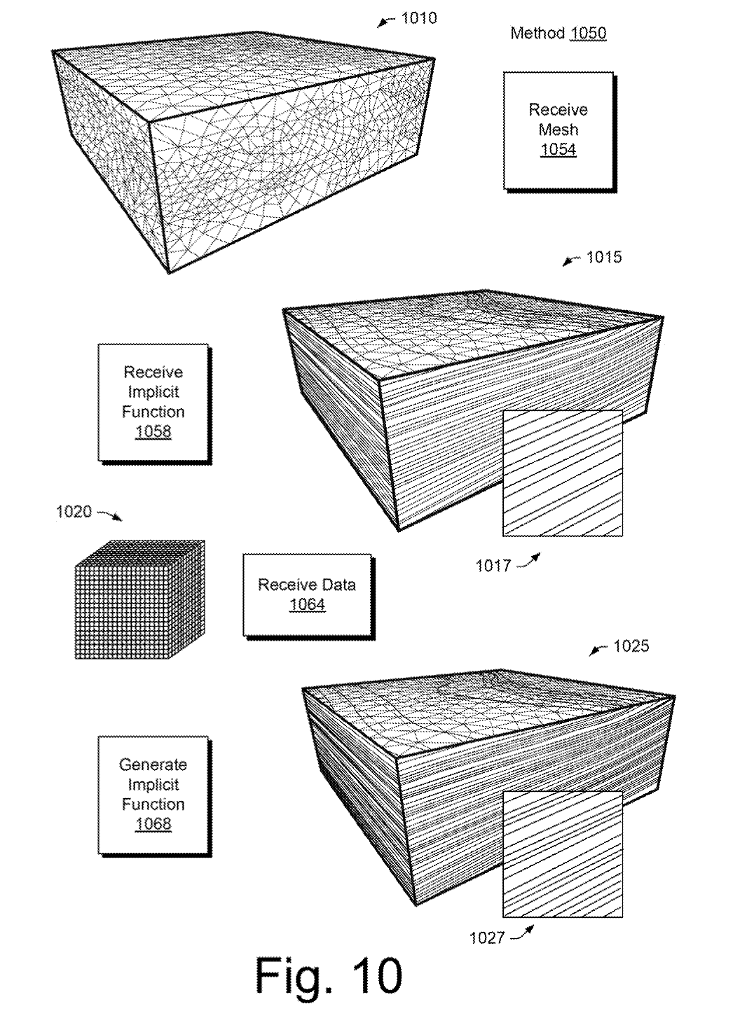

FIG. 10 shows an example of a method 1050 that includes a reception block 1054 for receiving a mesh, a reception block 1058 for receiving an implicit function, a reception block 1064 for receiving data and a generation block 1068 for generating an implicit function. In such an example, the reception block 1054 may receive a mesh such as the mesh 1010, which may include volume elements defined by nodes and connections between nodes. As an example, volume elements may include tetrahedra where each tetrahedron may be defined, for example, by four nodes (e.g., with respect to spatial coordinates).

As an example, an implicit function may be defined, for example, by solving a system of equations (see, e.g., the linear system of equations 530 of FIG. 5) for a volume of interest. As an example, the reception block 1058 may provide an implicit function for a volume of interest such as the volume of interest 1015 where, for example, the implicit function may include a spatial density or resolution, for example, as illustrated in an enlarged view 1017 of the volume of interest 1015.

As an example, the reception block 1064 may provide data such as seismic data that may be organized as a collection of volume elements (voxels) 1020. As an example, the density or resolution of the volume elements may be higher than the density or resolution of volume elements of a mesh. For example, the collection of volume elements 1020 may have a higher spatial resolution than the volume elements of the mesh 1010. In such an example, data is available at a higher spatial resolution that is higher (more refined) than that of a mesh.

As an example, the generation block 1068 may use data of the collection of volume elements 1020 to increase density or resolution of a provided implicit function such as the implicit function illustrated with respect to the volume of interest 1015. As an example, the generation block 1068 may provide for formulation of one or more constraints based at least in part on the data of the collection of volume elements (e.g., voxels) 1020, calculating a residual and using the residual to increase density or resolution of the implicit function. For example, FIG. 10 shows a volume of interest 1025 that includes a refined implicit function, for example, as illustrated in an enlarged view 1027 of the volume of interest 1025. As shown in the example of FIG. 10, the implicit function of the view 1027 has a higher spatial resolution than the implicit function of the view 1017.

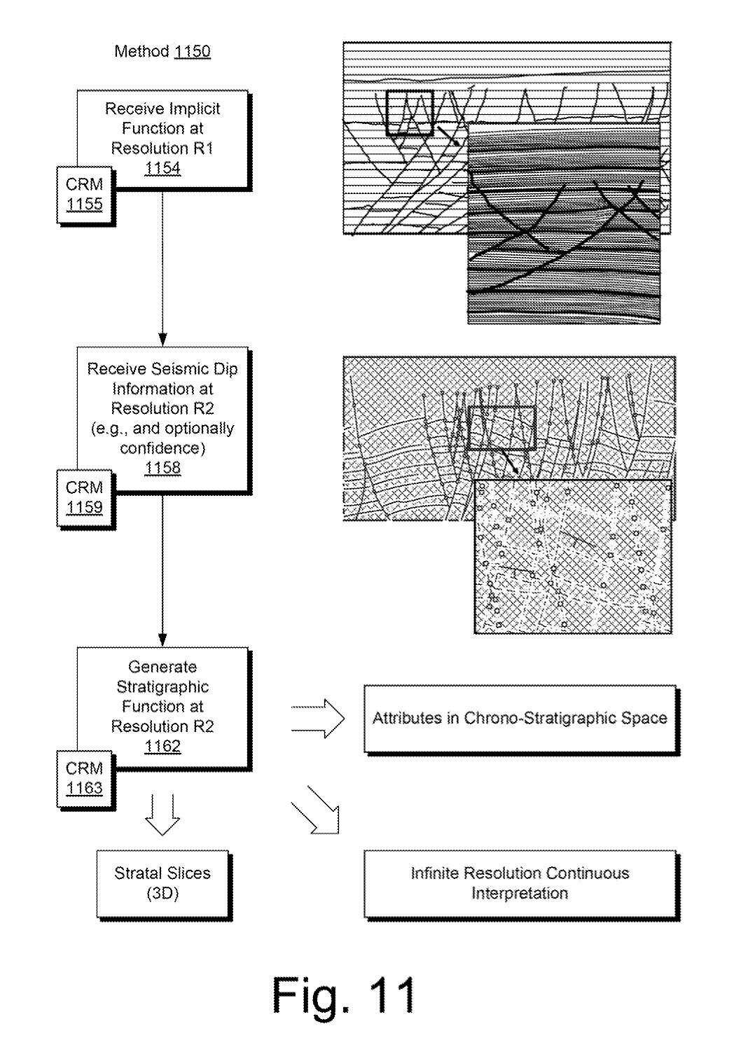

FIG. 11 shows an example of a method 1150 that includes a reception block 1154 for receiving an implicit function at a resolution R1, a reception block 1158 for receiving seismic dip information at a resolution R2 (e.g., and optionally associated confidence information), a generation block 1162 for generating a stratigraphic function (e.g., an implicit function) at the resolution R2.

The method 1150 may provide for generation of a more accurate and higher resolution stratigraphic function. As an example, a seismic cube may be processed for output of dip and azimuth to create a local topography that can update topography contained within an existing implicit function, for example, created using the seismic interpretation information (e.g., from human visual interpretation). As an example, a method may be iterative, for example, where seismic data has a resolution R10 and an implicit function has a lesser resolution R1 where at each iteration, an implicit function is generated using the seismic data to progressively achieve implicit function resolutions intermediate R1 and R10 and, optionally, an implicit function with a resolution R10 (e.g., matching that of the seismic data).

An implicit function may be computed as a scalar value, for example, defined at nodes of a background mesh (see, e.g., the mesh 1010 of FIG. 10) where the computation accounts for types of numerical constraints. As an example, some types constraints may be set to ensure that computed values fit input data, for example, such that a given interpreted horizon (e.g., via human visual interpretation) corresponds to a particular value of the implicit function. As an example, other types of constraints, which may be referred to as “regularization constraints”, may ensure spatial smoothness of a computed implicit function. In such a context, smoothness may provide for minimization of variation of dip and thickness of a geological layer (e.g., or layers).

As an example, one or more types of geometrical constraints may be formulated into linear equations (e.g., a system of linear equations) involving values of an implicit function at nodes of a mesh element, for example, where a coefficient may depend on shape of a mesh element and, optionally, where values attached to input data to be honored are constrained. As an example, a linear system of equations may be solved using a weighted least squares formulation. In such an example, weighting of the least squares system of equations may be adjusted to balance “importance” of various “data fitting” and regularization constraints, which may, for example, provide for smoother or rougher implicit functions. As an example, a weighting scheme may provide for balancing relative importance of various input data with respect to each other (e.g., seismic interpretation versus well tops).

As an example, to accommodate geological faults of arbitrary shapes, forming a fault network of arbitrary topology, a computation of a coarse scale implicit function may be performed on an unstructured mesh, for example, such that faults correspond to topological discontinuities (e.g., internal borders) of the mesh (e.g., where continuity of interpolation is controlled by adjacency relations in the background mesh).

The method 1150 is shown in FIG. 11 in association with various computer-readable media (CRM) blocks 1155, 1159, and 1163. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1150. As an example, a computer-readable medium (CRM) may be a computer-readable storage medium. As an example, the blocks 1155, 1159 and 1163 may be provided as one or more modules, for example, such as the one or more modules 407 of the system 401 of FIG. 4.

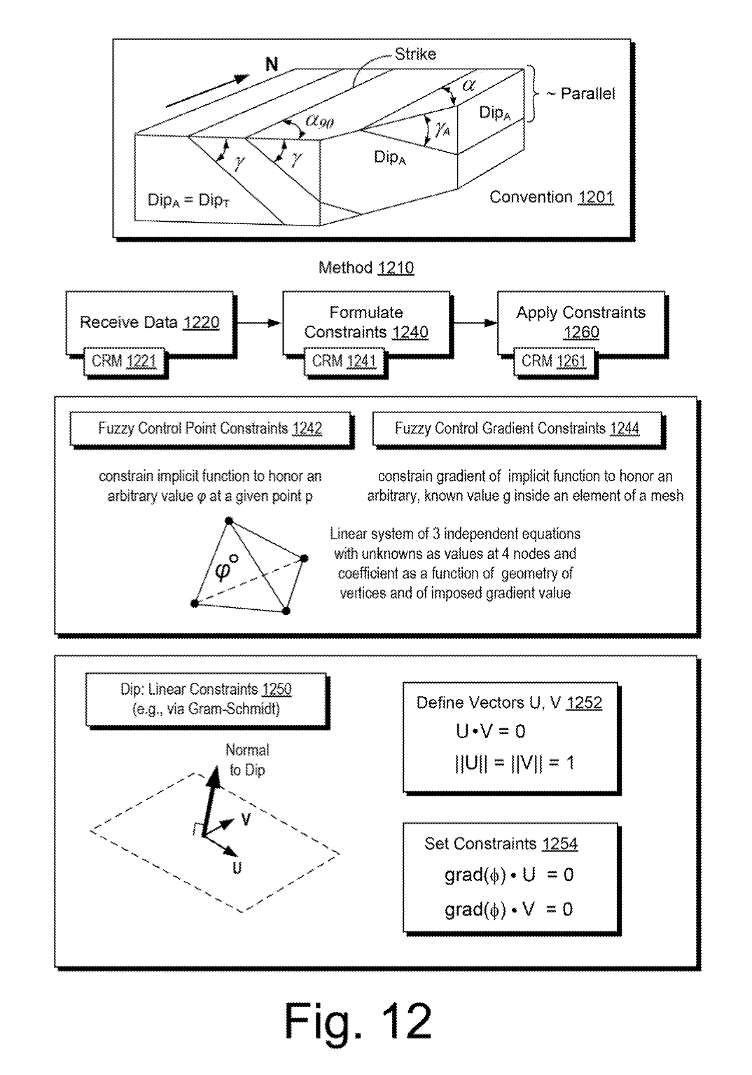

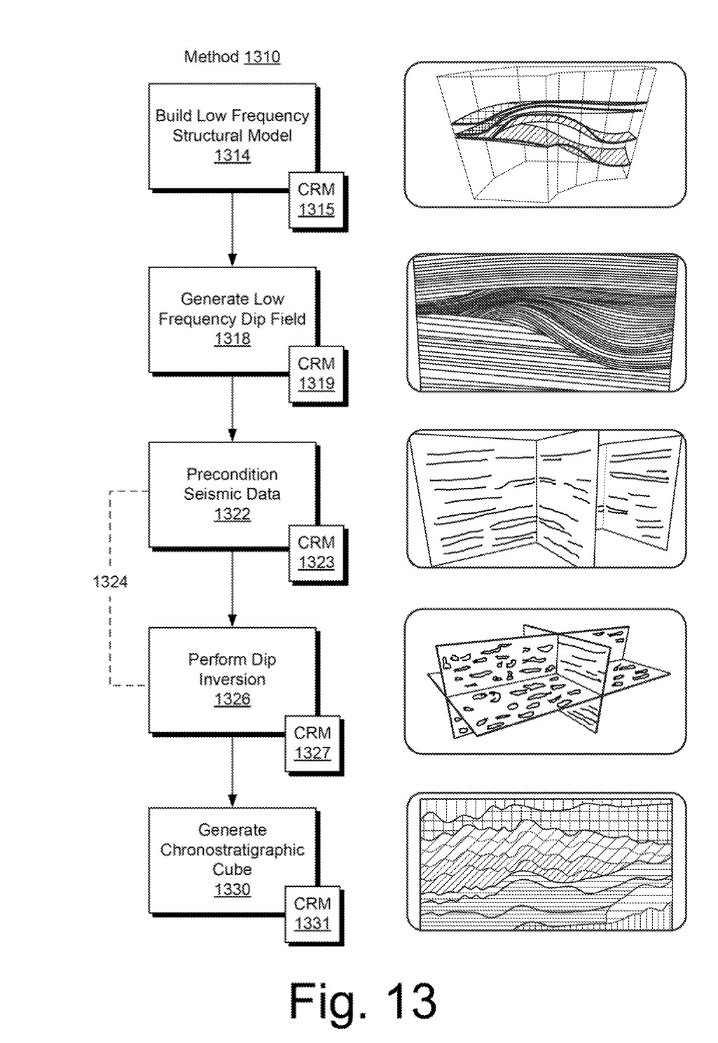

FIG. 12 shows an example of a convention for defining dip 1201 and an example of a method 1210 that includes a reception block 1220 for receiving data, a formulation block 1240 for formulating constraints and an application block 1260 for applying constraints.

As to the convention 1201 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 1201 of FIG. 12, various angles γ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 12 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 1201 of FIG. 12). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 1201 of FIG. 12). Apparent dip may be the dip of a plane as measured in any other direction except in the direction of true dip (see, e.g., γ_{A} as Dip_{A} for angle α); however, it is possible that the apparent dip is equal to the true dip (see, e.g., γ as Dip_{A}=Dip_{T} for angle α, with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 1201 of FIG. 12, the dip of a plane as seen in a cross-section perpendicular to the strike is true dip (see, e.g., the surface with γ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 1201 of FIG. 12, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 1201 may be used with respect to an analysis, an interpretation, an attribute, etc. (see, e.g., various blocks of the system 100 of FIG. 1, the block 1158 of FIG. 11, etc.). As an example, various types of features may be described, in part, by dip (e.g., sedimentary bedding, faults and fractures, cuestas, igneous dikes and sills, metamorphic foliation, etc.).

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

The method 1210 is shown in FIG. 12 in association with various computer-readable media (CRM) blocks 1221, 1241, and 1261. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1210. As an example, a computer-readable medium (CRM) may be a computer-readable storage medium. As an example, the blocks 1221, 1241 and 1261 may be provided as one or more modules, for example, such as the one or more modules 407 of the system 401 of FIG. 4.

As an example, a method may include formulating different types of constraints. For example, FIG. 12 shows a fuzzy control point constraint block 1242 for formulating fuzzy control point constraints and a fuzzy control gradient constraint block 1244 for formulating fuzzy control gradient constraints.

As an example, a constraint may be a data fitting constraint and a method may include formulating at least two different types of data fitting linear constraints. As to the aforementioned fuzzy control point type of constraint, it may be implemented to constrain an implicit function to honor (e.g., in a least squares sense) an arbitrary value q at a given point p (see, e.g., FIG. 5). As to the aforementioned fuzzy control gradient type of constraint, it may be implemented to constrain a gradient of an implicit function to honor (e.g., in a least squares sense) an arbitrary, known value “g” inside a volume element of a background mesh (e.g. a tetrahedron in three-dimensions, a triangle in two-dimensions, etc.).

As an example, for a tetrahedron, a fuzzy control gradient constraint may be expressed as a linear system of three independent equations that includes unknowns as values at vertices (e.g., nodes) of the tetrahedron (e.g., four nodes) and where coefficients may be a function of geometry of vertices and of an imposed gradient value.

As to the term “fuzzy”, this may infer that a constraint point is not at a point of an underlying mesh (e.g., at a node of an element of the mesh) but rather within the element (e.g., within a volume element, a surface element, etc.). Referring again to the example where data may be seismic data organized as a collection of voxels, for a region of interest of a geologic environment, the seismic data may include of the order of hundreds of millions of voxels while a mesh may include of the order of a few million volume elements (e.g., tetrahedra). In such an example, the seismic data has a higher spatial resolution than the mesh, which may be leveraged to increase resolution of an implicit function, for example, without increasing resolution of the mesh (e.g., without altering the mesh). As an example, a new, finer mesh may be generated, however, such a mesh may be for purposes of providing a higher resolution implicit function (e.g., with a resolution higher than that of a mesh such as a background mesh). As an example, a new, finer mesh may be an interpolation mesh that includes interpolated values of an implicit function subject to constraints (e.g., optionally based on a computed residual).

As an example, a voxel may include one or more values, which may be, for example, one or more attribute values. For example, a voxel may include an associated dip value and an associated confidence value for the dip value. As an example, where a mesh may have an approximate resolution of about hundreds of meters by about hundreds of meters, a collection of voxels may have an approximate resolution of about ten or tens of meters by about ten or tens of meters.

As an example, a method can include computing a final, fine scale implicit function (e.g., representing relative geological time at the scale of seismic signal data) φ_fine as a sum of a coarse scale implicit function (e.g., computed on a coarse scale unstructured mesh) φ_main and of a fine scale residual r, which may be expressed as, for example: φ_fine=φ_main+r.

As an example, a method may include computing φ_main using interpreted seismic data, constraining the computation by “control points” which geometry is defined by sets of points coming from seismic interpretation and which value v_control is a function of geological age of each of the interpreted horizon data. In such an example, the unknowns of a resulting linear system of equations may be values of φ_main at the nodes of the background mesh.

As an example, given values of φ_main at the nodes of the background mesh, a method may include computing a residual “r” by constraining the sum φ_main+r) to:
Honor control points coming from seismic interpretation v_control=(φ_main+r); noting that since this computation may be performed on a finer mesh than φ_main, and since the control points may be honored in a least squares sense in φ_main, such an approach is not strictly equivalent to a constraint of r=0 at the location of the control points;
Honor control gradients at locations where, for example, a local dip could be computed from an analysis of features of a seismic image; as an example, such constraints may specify that a gradient of (φ_main+r) honors computed dip values;
Ensure smoothness of the residual r itself; for example, using a regularization constraint such as, for example, a harmonic constraint where the value at a node is constrained (e.g., in a least squares sense) to honor a weighted average of the values of its topological neighbors;
Alternatively or additionally to the constraint c, a higher order regularization constraint (e.g. constant gradients or smooth gradients) that may be applied to a value of (φ_main+r), for example, to better constrain variations of a generated implicit function φ_fine.

As an example, while some constraints may apply to values of (φ_main+r), unknowns of a linear system of equations are values of r (e.g., the residual), while the values of φ_main may remain fixed. In such an example, the value of φ_main may be estimated at nodes of the finer “mesh”. As an example, values of a finer mesh may be computed via interpolating (e.g., linearly) the value of φ_main within an element of a coarse mesh. For example, a volume element of three-dimensional mesh may be a tetrahedron where higher resolution implicit function values are derived via interpolations within the tetrahedron, for example, using values at nodes that define the tetrahedron and using values of the residual, which may be defined at a higher resolution (e.g., to include nodes inside the tetrahedron). As an example, a method may include solving a linear system of equations to provide a value for a residual at each node of a higher resolution mesh (e.g., a mesh having a resolution based at part on data that has a higher resolution than a coarse mesh). As an example, a fine resolution mesh may be a vertical 2D structure grid or a structured 3 dimensional grid (e.g., at a resolution of a seismic image, for example, one node or cell per seismic voxel), or at a multiple of a resolution of a seismic image (e.g. a constant number of seismic voxels per cell, etc.).

As an example, to generate a higher resolution implicit function (e.g., φ_fine), a method may include computing φ_fine by adding values of φ_main and of the residual “r” at the nodes of the finer mesh. In such an example, the value of the implicit function can then be evaluated (e.g., determined) at each point of the finer mesh by interpolating it (e.g., linearly, tri-linearly, etc. within each element of the finer mesh).

As an example, a set of confidence factors (e.g., associated with each of measured dip values and representing the degree of certainty of the measure of the dip) may be accounted for during calculation of a residual r. As an example, a confidence factor may be a value linked with quality of a seismic signal at a spatial location (e.g., within a region of interest).

As an example, confidence factors may be translated into a set of coefficients that may be used to weight corresponding linear equations prior to processing to achieve a finer resolution (e.g., of a least squares system). As an example, a weighted least squares system may be generated in an automated manner, for example, using seismic data optionally without user interaction (e.g., for assessing the data, etc.). As an example, for dip data for which a confidence factor may be below an arbitrary or predetermined threshold may be discarded from a system of equations (e.g., filtered out, etc.).

As an example, as a result of interpolation, a fine scale implicit function φ_fine may be such that it honors both input interpretation points and subtle topography changes, for example, such as those observed in a seismic image. As an example, such an approach may help to avoid having a low signal to noise region in seismic data resulting in interference (e.g., with quality of results).

FIG. 12 also shows an approach that can implement linear constraints. For example, a block 1250 can use linear constraints as to dip (e.g., as may be locally specified in a volume). As shown, a dip information may be provided for a local region where the dip information may be, for example, a dip vector (e.g., or information sufficient to form a dip vector, etc.) and/or a vector perpendicular (e.g., a normal vector) to a surface (e.g., a horizon surface). As an example, a dip vector may be based on information such as seismic information, borehole information, etc. As an example, a dip vector (e.g., and/or a normal vector) for a particular region may be an interpolated value, for example, based at least in part on another measured, interpreted, etc. vector or vectors (e.g., dip, normal, etc.).

As an example, dip information may be for a layer such as a layer of sediment or dip information may be for another type of feature. For example, a geobody may be defined at least in part by dip information. As an example, consider a salt dome that may be formed by intrusion of evaporite minerals (e.g., salt, or halite) into surrounding rock (e.g., forming a diapir, etc.). With respect to petroleum systems, as a salt structure may be relatively impermeable, it may act as a trap (e.g., a stratigraphic trap, etc.).

In the example of FIG. 12, a dip related constraint may be a linear constraint that can allow for generation of a set of linear equations. In such an example, a linear solver may be implemented to provide one or more solutions to the set of linear equations.

As shown in the example of FIG. 12, the block 1250 may include sub-blocks 1252 and 1254 for generating new linear constraints relating the direction of the gradient of the implicit function to vectors created using for example a Gram-Schmidt approach (e.g., a Gram-Schmidt algorithm). As shown, the block 1252 includes defining vectors U and V that can be orthogonal and orthonormal and the block 1254 includes setting constraints with respect to the defined vectors U and V, for example, a orthogonal gradient constraint with respect to the vector U and a orthogonal gradient constraint with respect to the vector V. As to dip, where a normal vector is provided or otherwise determined for a local region (e.g., the normal vector being normal to a horizon(s)), the block 1252 can define the vectors U and V as being orthogonal to the normal vector. As an example, a dip vector (e.g., a vector in a plane of a dipping horizon, etc.) may be received for a local region from which a corresponding normal may be deduced (e.g., determined, calculated, etc.).

As mentioned, linear constraints can allow for generation of a linear system of equations, which may be amenable to solution via one or more linear solvers. As an example, a linear system of equations can include at least one linear dip constraint that acts to constrain a gradient with respect to dip. For example, consider a “control gradient direction” constraint.

In the example of FIG. 12, the block 1250 may provide a “control gradient direction” constraint or constraints that can constrain the scalar products of a gradient and of two vectors that are perpendicular to dip (e.g., seismic dip, borehole dip, etc.) to be null. As explained, such a control gradient constraint can be expressed as a linear constraint.

As an example, a method can include arbitrarily defining (e.g. using a Gram-Schmidt algorithm) two unit vectors U and V that perpendicular to each other and perpendicular to a normal vector for a local region (e.g., extracted from a seismic image and/or other data). In such an example, the method may include setting the following constraints: grad(φ)·U=0; and grad(φ)·V=0. As an example, a constraint may be based on setting a scalar product to a particular value, which may be zero. As an example, a constraint may be based on a dot product of a gradient of a field (e.g., a function, etc.) and unit vector. As an example, a constraint may be based on a vector associated with a Gram-Schmidt approach where such a vector may be, for example, a unit vector.

In the foregoing example, as the gradient of can be expressed as a linear function of the values of φ (e.g., at nodes of cells of an underlying mesh), linear equations can be obtained.

As an example, a method can include weighting one or more linear constraints. For example, a method can include weighting one or more control gradient direction constraints that are cast as one or more linear constraints. As mentioned, such a control gradient constraint may be based at least in part on a vector determined via data (e.g., measured data, interpreted data, etc.). As mentioned, a vector may be a dip vector. As an example, a weight may be based on uncertainty and/or quality of data and/or a vector estimate.

As another example, where quality of data (e.g., seismic and/or other data used to estimate dip vector) varies, a method can include weighting one or more linear constraints based at least in part on a quality metric. For example, a particular receiver in an array may be subject to noise at a level that exceeds noise of one or more other receivers in the array. Where such information is known a priori, a vector determined based at least in part on data acquired by that particular receiver may have one or more associated linear constraints that are assigned a weight (e.g., or weights) that diminishes influence on a solution to a system of linear equations.

As an example, where a region includes seismic data and borehole data, a vector estimated based on such data may be assigned to a high quality class of a spectrum of quantitatively identifiable classes (e.g., from low quality to high quality). In such an example, an associated linear constraint (e.g., a control gradient direction constraint) may be assigned a weight that depends on the quality class and/or, for example, one or more other linear constraints may be assigned a corresponding weight or weights that indicate local data is not of the highest quality of a spectrum of quantifiably identifiable classes.

As an example, one or more statistical techniques may be applied to data to determine a class for such data. As an example, one or more statistical techniques may be applied to a vector based on data to determine a class for the vector.

As an example, a method can include weighting (e.g., using weighted least squares) one or more control gradient direction constraints using uncertainty and/or quality of dip information (e.g., dip vectors, seismic dip information, borehole dip information, etc.).

As an example, a solution to a linear system of equations may be rendered to a display in a manner that indicates quality and/or uncertainty. For example, a volume may be rendered to a display that illustrates a solution associated with a refined mesh, refined using dip information. In such an example, color coding may be used to highlight regions of the volume where the dip information (e.g., dip vectors, etc.) may be quantitatively and/or qualitatively certain, uncertain, low quality, high quality, etc. Such an approach may include accessing one or more weights as may be associated with one or more linear constraints. For example, a method can include accessing control gradient direction constraint weights for local regions and rendering colors (or other indicia) to a display. In such an example, a use may assess a solution with respect to quality and/or uncertainty of information used to generate that solution.

As an example, a method can include updating a pre-existing stratigraphic function, for example, generated via construction of a volume-based structural framework. In such an example, the updating may include receiving dip information, which may, for example, pertain to one or more structural features of one or more regions of a volume. As an example, the dip information may be provided as a seismic “consistent dip” cube. As an example, updating may include setting one or more linear constraints, for example, as gradient-based constraints. As an example, one or more linear constraints may be weighted, for example, where one or more weights depend on factors such as quality and/or uncertainty (e.g., of dip information, vector information, etc. in a region).

As an example, updating may act to increase resolution of one or more stratigraphic functions in one or more regions of a volume, for example, by “flexing” a “relative age cube” locally and “morphing” one or more regions of seismic reflector topology onto it.

As an example, updating may act to refine one or more features with considerable deformation (e.g., geobodies, etc.). As an example, an approach may include refining a stratigraphic function in a region that includes at least a portion of a salt dome. For example, vector information may be given for the salt dome and linear gradient constraints formulated based at least in part on the vector information. As an example, a weighting approach to weighting linear constraints to “overemphasize” a geobody contour with respect to one or more surrounding contours (e.g., horizons, etc.).

As an example, a method can include rendering a graphical user interface (GUI) to a display, receiving a signal (or signals) via the GUI and selecting a weight or weights based at least in part on the signal (or signals) where the weight or weights pertain to a structural feature such as, for example, a geobody. In such an example, a user may input various weights to morph a solution with respect to “influence” of a structure that may exhibit deformation that is greater than deformation of one or more neighboring structures (e.g., horizons, etc.).

As an example, a method may include using a geologically consistent, sealed structural model and then refining a mesh associated with the model using information such as vectors (e.g., dip vectors, etc.).

As an example, a method can include receiving vector information for a plurality of local regions in a volume and refining at least one region of a stratigraphic function based on at least a portion of the received vector information. In such an example, the refining may include solving a linear system of equations using a linear solver where a solution is constrained by at least one linear gradient constraint that depends at least in part on vector information. For example, consider a local regional linear gradient constraint as formulated using a Gram-Schmidt algorithm and a local regional dip vector.

As an example, a method of refining a stratigraphic function may be vector-based in that vectors are specified and linear gradient constraints formulated based at least in part on the vectors. Such an approach may include generating a linear system of equations that is relatively robust and capable of handling deformation such as deformation associated with structural features such as one or more geobodies.

FIG. 13 shows an example of a method 1310 that includes a build block 1314 for building a low frequency structural model, a generation block 1318 for generating a low frequency dip field, a precondition block 1322 for preconditioning seismic data, a performance block 1326 for performing a dip inversion and a generation block 1330 for generating a chronostratigraphic cube (e.g., chronostratigraphic data). As indicated in the example of FIG. 13, a loop 1324 may exist between the performance block 1326 and the precondition block 1322, for example, to provide for iterations (e.g., successive preconditioning and inversion).

As an example, the method 1310 may provide for iterative refinement of a stratigraphic function, for example, to progressively increase details of a dip field (e.g., while maintaining stability during merging). In such an example, details may include information as to dip, slope of a surface, etc.

The method 1310 is shown in FIG. 13 in association with various computer-readable media (CRM) blocks 1315, 1319, 1323, 1327 and 1331. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1310. As an example, a computer-readable medium (CRM) may be a computer-readable storage medium. As an example, the blocks 1315, 1319, 1323, 1327 and 1331 may be provided as one or more modules, for example, such as the one or more modules 407 of the system 401 of FIG. 4.

As an example, seismic data may be in or transformed to a frequency-wavenumber domain, for example, where independent variables are frequency “f” and wavenumber “k” (e.g., consider a Fourier transform of a seismic record or seismic section). A frequency-wavenumber domain may be referred to as an FK space.

As an example, a method may include FK filtering (e.g., FK dip or fan filtering). As an example, data may be transformed into an FK domain (e.g., prestack, post-stack, etc.). As an example, indicia of noise may be identified in an FK domain, for example, to help determine an approach to filtering that may be applied to data, for example, followed by an FK inverse transform.

As an example, the build block 1314 may allow for input of stratigraphic information such as, for example, one or more erosive surfaces. As an example, the generation block 1318 may provide for generation of field with an implicit function that may account for structural inputs such as faults, sequence boundaries, layer discontinuities, etc. As an example, the precondition block 1322 may include applying a low frequency filter to seismic data, performing FK filtering, performing structural smoothing using a low frequency dip field (e.g., where an operator size may depend on a low-pass and/or FK filter). As an example, the performance block 1326 may include generating an updated dip field using preconditioned seismic data and a low frequency dip field, for example, via inversion. In such an example, resolution of the updated dip field may approach that of a particular parameter. As an example, the generation block 1330 may include receiving a user specified resolution of a chronostratigraphic cube. As an example, the generation block 1330 may include generating output (e.g., chronostratigraphic data) where pre-interpreted structures are honored.

As to the aforementioned loop 1324, it may include, for example, updating a frequency filter range, a FK filter range, re-running a structural smoothing process, for example, using the updated dip field (e.g., updated model).

As mentioned, a method can include interpolating an implicit function on a cross-section through a model space. For example, a method can include interpolating an implicit function on a vertical two-dimensional cross-section through a model where the model may be a three-dimensional model. As an example, a method can include interpolating by at least in part constraining the interpolation by dip information such as, for example, apparent dip of seismic horizons. For example, consider constraining an interpolation of a function by dip information such as, for example, apparent dip of seismic horizons on a section through a model (e.g., a model space).

As an example, a method can include interpolating a function (e.g., an implicit function) via dip information. As an example, a system can render information to a display where input received via an input mechanism (e.g., a mouse, a touch screen, etc.) can select a plane within a multidimensional space that may correspond to a model space for which an implicit function may be defined. In such an example, the system may receive a command that initiates a refinement technique to at least a portion of the plane (e.g., a space defined at least in part by the plane, including at least a portion of the plane, etc.). In such an example, a dip analysis may be performed that analyzes dip information to formulate constraints for the refinement technique. Such an analysis may optionally occur automatically, for example, responsive to receipt of a command by the system. As an example, the refinement technique may output results that can be rendered to the display. For example, the plane may be rendered based at least in part on the results such that the plane is displayed as being refined with respect to information displayed therein.

As an example, dip information may be available for a portion of a space that may be represented by a model. In such an example, an implicit function for the portion of the space may be refined using the dip information. As an example, dip information may be lacking or not reliably estimated for a portion of a space that may be represented by a model. In such an example, apparent dip information may be used to constrain a three-dimensional interpolation of an implicit function.

As an example, a method can include controlling the apparent dip of one or more horizons and/or salt interfaces on a plane or a set of planes. For example, where orientation data are available in the form of apparent dip values measured along a cross-sectional plane (e.g. on a seismic section), the orientation of the projection of the gradient vector onto the plane may be constrained.

As an example, let ii be the vector normal to a plane and \vec{p} be a projection of a gradient of an implicit function φ onto the plane (e.g., \vec{p}=\vec{n}×\vec{∇}(φ)×\vec{n}), and pᵤₙᵢₜ be the unit vector of the same orientation \vec{p}/∥\vec{p}∥, then, in such an example, an “apparent dip” constraint may be expressed as, for example: \vec{∇}(φ). (\vec{n}×\vec{p}ᵤₙᵢₜ)=0. In such a formulation, the unit vector may be the interpreted normalized apparent dip (e.g., a normal vector of a multi_z interpretation object).

A constraint such as the aforementioned “apparent dip” constraint may be, for example, used to enhance control over an interpolated function, for example, where seismic information is interpreted on 2D lines, or where, for example, a multi-z interpretation object (e.g., a polyline associated with apparent dip information in the form of normal vectors) is used to define a location of a salt body (e.g., or other geobody). As an example, a constraint formulated using vectors, gradients, dot products, etc. may be used in within a framework, for example, to avoid artifacts linked to a current placement of one or more offset points.

As an example, a geologic environment may be characterized with respect to system tracts. For example, consider a systems tract as a sequence subdivision that includes one or more depositional units that may differ in geometry from another systems tract. As an example, seismic data may be processed to estimate one or more boundaries that may define, at least in part, a systems tract.

As an example, different systems tracts may represent different phases of eustatic changes. Eustasy pertains to sea level and its variations. Thus, eustatic changes may pertain to sea level changes, which may result, for example, from movement of tectonic plates that alter volume of an ocean basin, from climate effects on volume of water stored in glaciers/icecaps, etc. Eustasy can affect positions of shorelines and processes of sedimentation, which can make interpretation of eustasy a useful aspect of sequence stratigraphy.

As an example, a lowstand systems tract may develop during times of relatively low sea level; a highstand systems tract may develop at times of high sea level; and a transgressive systems tract may develop at times of changing sea level.

A lowstand systems tract (LST) may be a systems tract overlying a sequence boundary and overlain by a transgressive surface. A lowstand systems tract may be characterized by a progradational to aggradational parasequence set. As an example, a lowstand systems tract may be a basin-floor fan, a slope fan, a lowstand wedge, etc.

A highstand systems tract (HST) may be a systems tract bounded below by a downlap surface and above by a sequence boundary. A highstand systems tract may be characterized by an aggradational to progradational parasequence set.

As an example, method may provide for automatic systems tract detection. For example, consider a method that includes providing a defined 3D stratigraphic function; automatically detecting a continental shelf break; and based on one or more predefined rules (e.g., aggradation, progradation, retrogradation, forced regression, etc.), characterizing behavior of the continental shelf break (e.g., where the process may be able to identify systems-tracts).

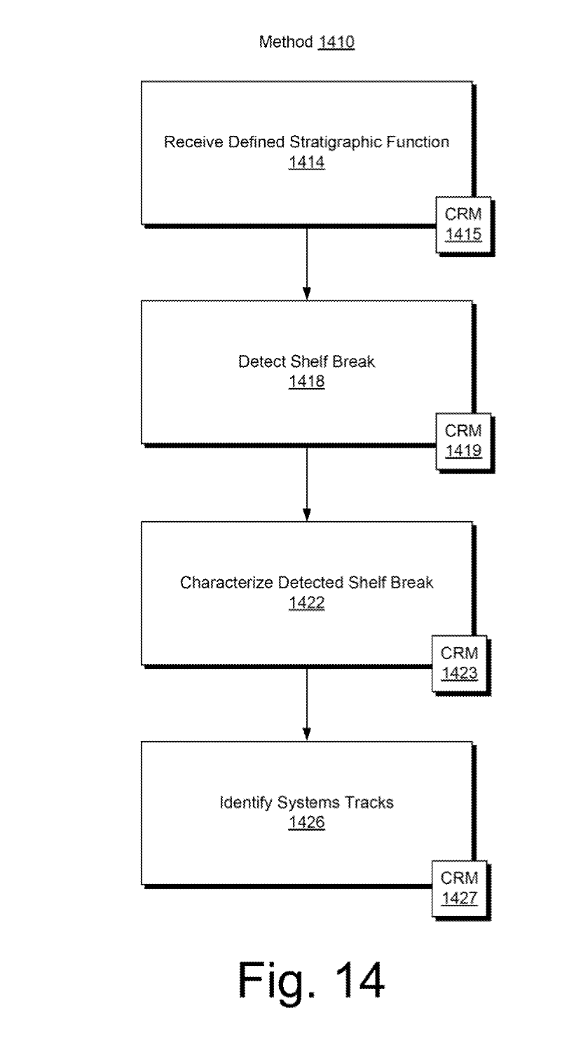

FIG. 14 shows an example of a method 1410 that includes a reception block 1414 for receiving a defined stratigraphic function, a detection block 1418 for detecting a shelf break, a characterization block 1422 for characterizing the shelf break and an identification block 1426 for identifying at least one tract (e.g., a systems tract). In the method 1410, the defined stratigraphic function may be derived according to a method such as, for example, the method 1150 of FIG. 11. For example, local seismic dip information may be received along with an implicit function to define a stratigraphic function, which may have resolution finer than that of the implicit function.

The method 1410 is shown in FIG. 14 in association with various computer-readable media (CRM) blocks 1415, 1419, 1423, and 1427. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1410. As an example, a computer-readable medium (CRM) may be a computer-readable storage medium. As an example, the blocks 1415, 1419, 1423, and 1427 may be provided as one or more modules, for example, such as the one or more modules 407 of the system 401 of FIG. 4.

As an example, dip information may be generated by processing seismic information. In such an example, an algorithm or algorithms may operate in an automated (e.g., or semi-automated) manner to generate dip information. For example, a method can include receiving a seismic cube of seismic data for a geologic environment, processing the seismic cube for dip information, receiving an implicit function for at least a portion of a the geologic environment and generating a stratigraphic function that has a resolution finer than that of the implicit function. Given the stratigraphic function, one or more actions of the method 1410 may be performed, optionally in an automated manner, for example, to detect a shelf break, characterize a shelf break, identify a tract, etc.

As an example, a method may include receiving information as to identity of one or more sequence boundaries. As an example, a method can include identifying one or more sequence boundaries.

As an example, a shelf break may be a continental shelf break, for example, an area at an edge of a continent from a shoreline. For example, consider an edge at a depth of about 200 m where a continental slope begins.

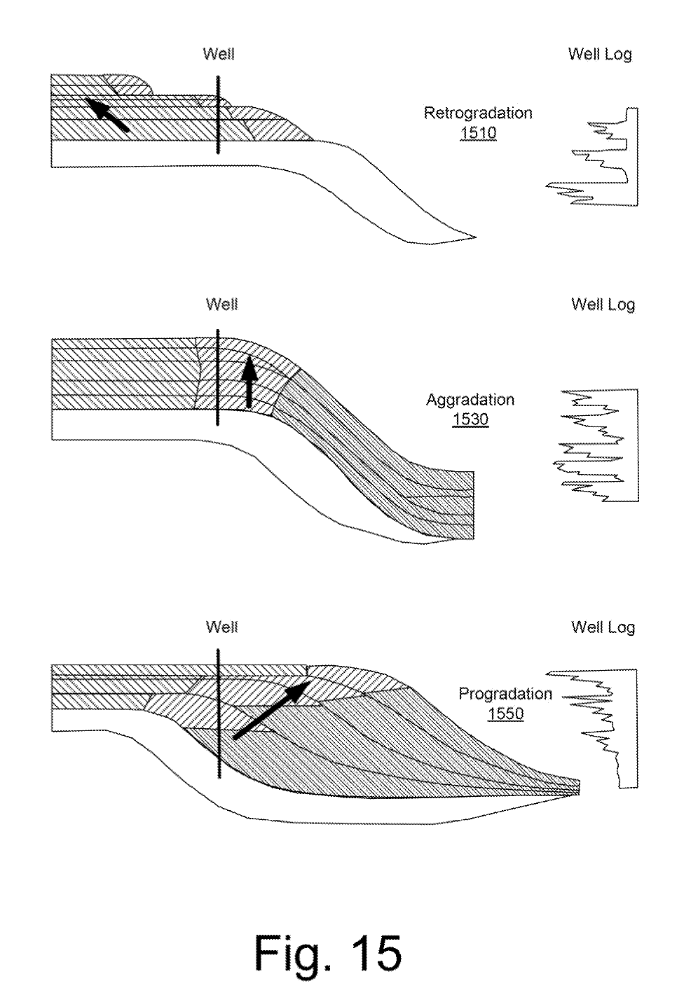

Various examples of techniques, technologies, etc. described with respect to FIGS. 15 to 18 may include use of an implicit function representing chronostratigraphic time. In such examples, such an implicit function may be an un-refined-scale implicit function (e.g., one that has not been refined using dip information, vector information, etc.) or a refined-scale implicit function (e.g., one that has been refined using dip information, vector information, etc.).

FIG. 15 shows example graphics 1510, 1530 and 1550 with respect to systems tract separation identification, for example, where identification may be based in part on data such as well log data. The graphic 1510 shows an example of a retrogradation scenario with a well and an example of a corresponding well log. The graphic 1530 shows an example of an aggradation scenario with a well and an example of a corresponding well log. The graphic 1550 shows an example of a progradation scenario with a well and an example of a corresponding well log.

As an example, retrogradation may be characterized by accumulation of sequences by deposition in which beds are deposited successively landward, for example, where sediment supply may be limited and unable to fill available accommodation. For example, the position of a shoreline may migrate backward onto land, a process called transgression, during episodes of retrogradation.

As an example, aggradation may be characterized by accumulation of stratigraphic sequences by deposition that stack beds atop one another, for example, building upwards during periods of balance between sediment supply and accommodation.

As an example, progradation may be characterized by accumulation of sequences by deposition in which beds are deposited successively basinward, for example, where sediment supply exceeds accommodation. For example, the position of a shoreline may migrate into a basin during episodes of progradation (e.g., regression).

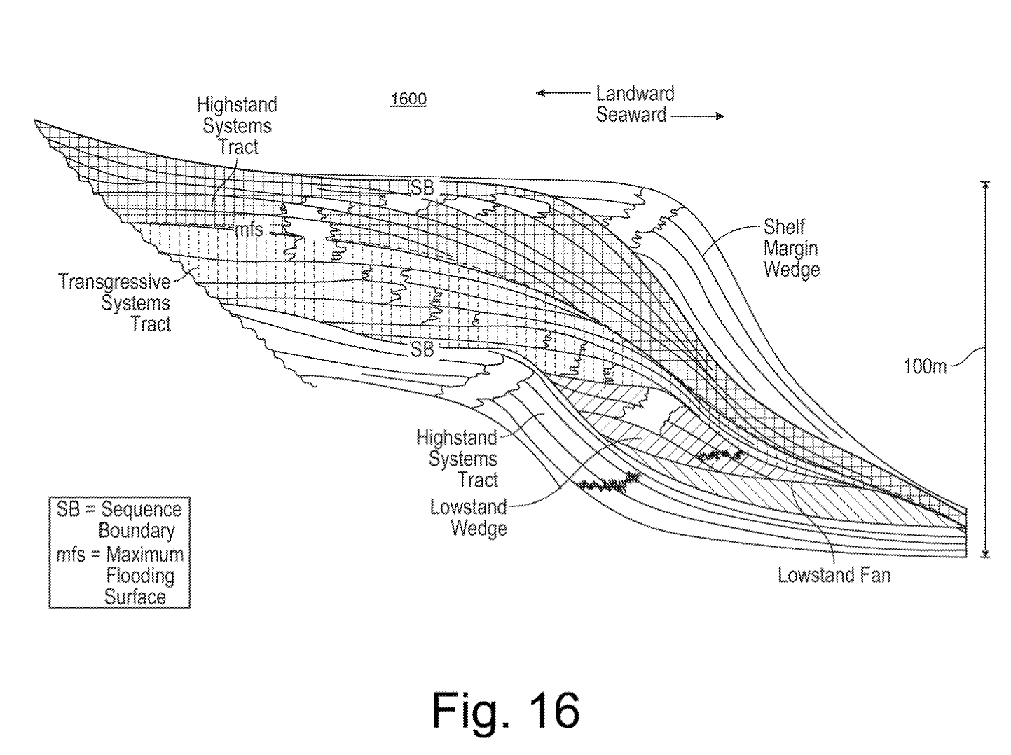

FIG. 16 shows an example of a graphic 1600 with respect to sequence stratigraphy identification. As an example, a method may include providing an implicit function and identifying sequence boundaries. The graphic 1600 shows examples of sequence boundaries, one or more HSTs, a transgressive systems tract (TST), a shelf margin wedge, a lowstand fan, lowstand wedge, etc.

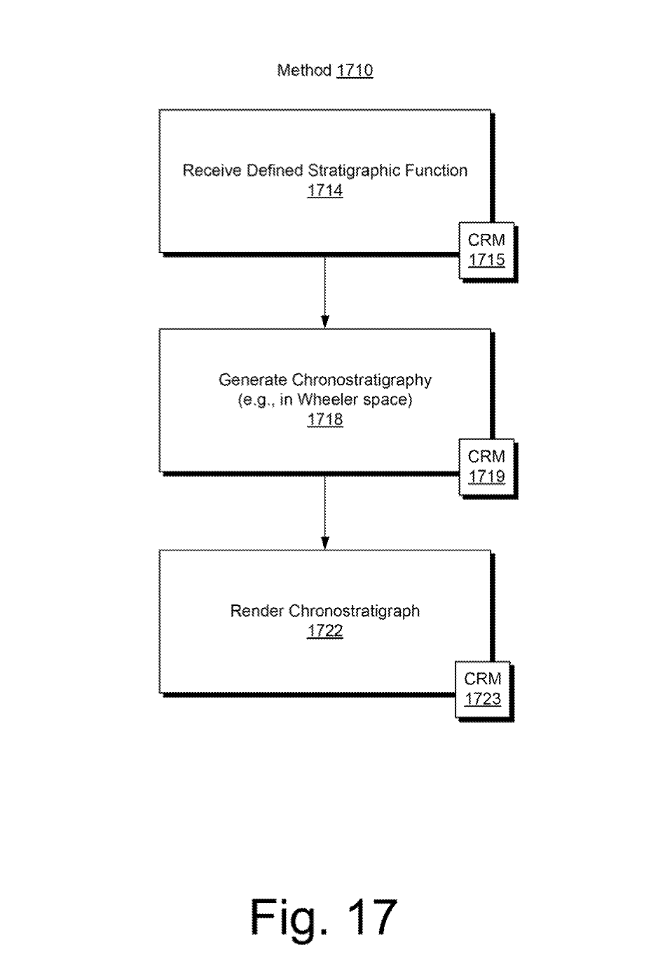

FIG. 17 shows an example of a method 1710 that includes a reception block 1714 for receiving a defined stratigraphic function (e.g., refined or un-refined), a generation block 1718 for generating chronostratigraphy (e.g., information in a Wheeler space), and a render block 1722 for rendering a chronostratigraph (e.g., a chronostratigraphic view of a sub-surface region).

The method 1710 is shown in FIG. 17 in association with various computer-readable media (CRM) blocks 1715, 1719 and 1723. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1710. As an example, a computer-readable medium (CRM) may be a computer-readable storage medium. As an example, the blocks 1715, 1719 and 1723 may be provided as one or more modules, for example, such as the one or more modules 407 of the system 401 of FIG. 4.

As an example, a workflow may include analyzing depositional history. As an example, variation in lateral extent of seismic features may be analyzed in a chronostratigraphic order. As an example, a Wheeler representation of information (e.g., in a Wheeler space or Wheeler domain) may be generated to illustrate migration of depositional source material and, for example, to reveal depositional history based on super-position placement on a time-history axis. As an example, an analysis of seismic stratigraphy and borehole geology (e.g., well logs) may provide insight as to facies distribution (e.g., consistent with borehole bedding and orientation interpretation).

As an example, a workflow may include analyzing information pertaining to a geologic environment where the information may include information such as seismic information and, for example, well log information. In such an example, the workflow may include removing faulting (e.g., and one or more other deformations) to correlate at least a portion of seismic information to depositional units in one or more horizontal stratigraphic sequences.

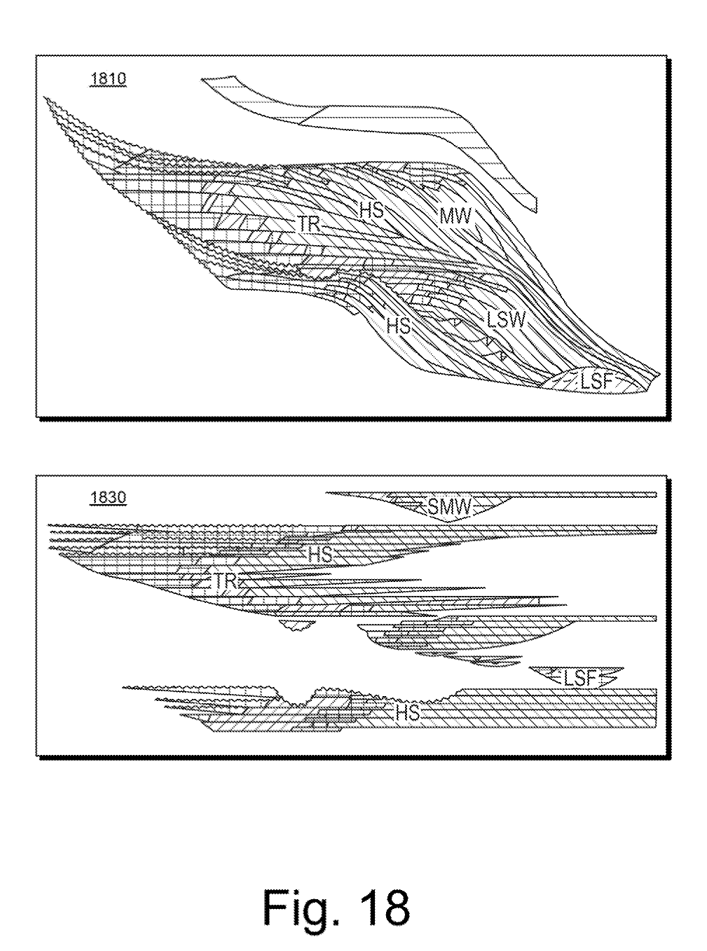

FIG. 18 shows examples of graphics 1810 and 1830 corresponding to a stratigraphic function and a Wheeler space transformation thereof, respectively. In FIG. 18, the graphic 1810 shows various regions (e.g., MW, HS, TR, LSF, LSW, etc.) with respect to depth (e.g., a physical space or physical domain); whereas, the graphic 1830 shows relatively horizontal lines across various regions (e.g., MW, HS, TR, LSF, LSW, etc.) where such lines correspond to relative geological times (e.g., a time space or time domain). In FIG. 18, LSF corresponds to a lowstand fan, LSW corresponds to a lowstand wedge, HS corresponds to a highstand systems tract (e.g., also HST), TR corresponds to a transgressive systems tract (e.g., also TST), MW/SMW correspond to a shelf margin wedge, and CS corresponds to a condensed section.

In a Wheeler space, an analysis may include identification of one or more systems tracts, one or more water level changes, one or more shore/edge changes. Such information may aid in identification of one or more features, processes, etc. associated with a petroleum system (e.g., source rock, seals, traps, etc.).

As an example, a method may include automatic reconstruction model building. As an example, a method may include transforming information to a Wheeler space (e.g., or Wheeler domain) and transforming information from a Wheeler space (e.g., or Wheeler domain). As an example, a workflow may include model building and may include transforming information. As an example, a workflow may include editing information in a domain and transforming that information after editing.

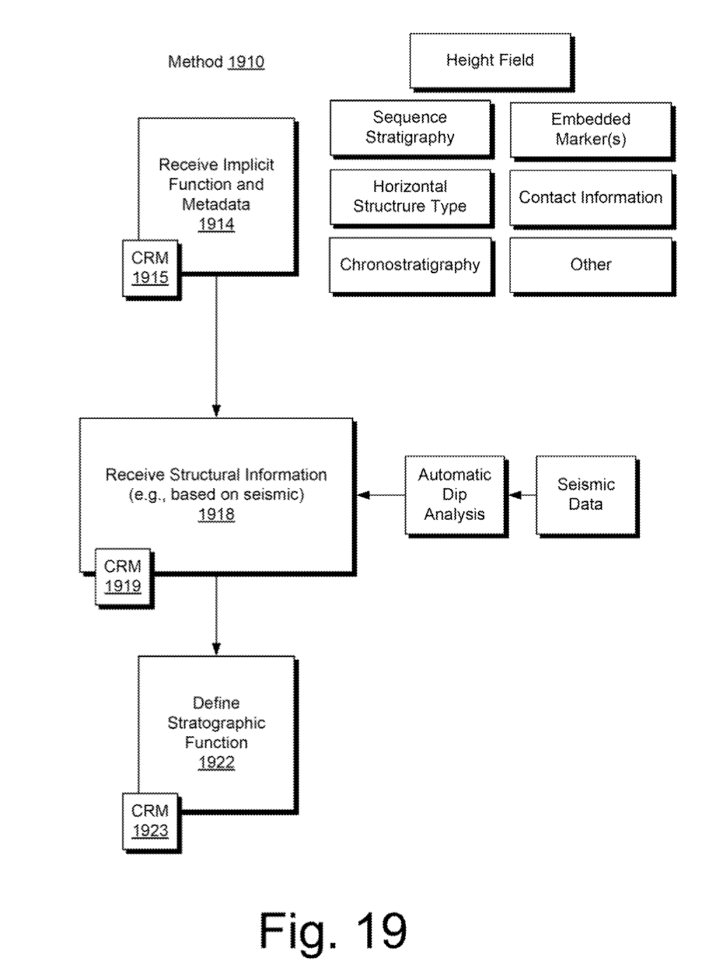

FIG. 19 shows an example of a method 1910 that includes a reception block 1914 for receiving an implicit function and metadata, a reception block 1918 for receiving structural information and a definition block 1922 for defining a stratigraphic function, for example, based on the implicit function, at least a portion of the metadata and at least a portion of the structural information.

The method 1910 is shown in FIG. 19 in association with various computer-readable media (CRM) blocks 1915, 1919 and 1923. Such blocks generally include instructions suitable for execution by one or more processors (or cores) to instruct a computing device or system to perform one or more actions.

While various blocks are shown, a single medium may be configured with instructions to allow for, at least in part, performance of various actions of the method 1910. As an example, a computer-readable medium (CRM) may be a computer-readable storage medium. As an example, the blocks 1915, 1919 and 1923 may be provided as one or more modules, for example, such as the one or more modules 407 of the system 401 of FIG. 4.

In the example of FIG. 19, the implicit function may be defined as a height field, for example, a field that includes series of values associated with depths. As to metadata, such data may include sequence stratigraphy data, horizontal structural type data, chronostratigraphy data, embedded marker data (e.g., as may be associated with one or more wells, well tops, etc.), contact data (e.g., as to contact of materials), and other data.

As an example, the structural information of the reception block 1918 of the method 1910 may be generated based on seismic data. For example, an automatic dip analysis may be performed on seismic data to generate dip data as structural information.

As an example, horizon structural type data may specify a type such as, for example, erosional, conformable, base, etc. As an example, sequence stratigraphy data may include, for example, MFS, SB, TS, etc. (e.g., systems tract information). As an example, an embedded marker may be linked to a well top (see, e.g., the wells of FIG. 15). As an example, chronostratigraphy data may include one or more links to a chronostratigraphic chart/column, for example, to provide absolute age information, etc. As an example, contact information may be available where a process (e.g., a workflow) can include picked specific stratigraphic terminations on a seismic volume (e.g. top-laps/on-laps, down-laps, truncations, fault cuts, bedding trends, etc.). Such information may be consumable by the process to refine a stratigraphic model.

As an example, a method may include receiving local bedding trends (e.g., located in-between, above or below seismic horizons). In such an example, the bedding trends may correspond to locally consistent seismic signals that may be interpreted while a corresponding geological horizon may be uncertain (e.g., not clearly identifiable). As an example, a bedding trend may be a shape on a seismic image that corresponds to an iso-value of an implicit function (e.g., to a constant relative stratigraphic age), however, assignment to a given horizon may have some uncertainty, for example, the lateral continuity of an event may be unknown. As an example, a linear constraint for one or more bedding trends may be akin to that for fault displacement, for example, the implicit function value of a set of points may be set equal to each other.

As an example, a linear numerical constraint may be included in a system of equations used to interpolate an implicit function. For example, consider imposing a constraint that a difference of implicit function values between one arbitrarily selected point and other points of a set are approximately zero (e.g., or zero). As to fault displacement control, where a fault displacement has been selected (e.g., picked) on a seismic images (e.g., as a segment linking two corresponding points located on either side of a fault), to specify a value at the location of both points can be similar. As an example, where a fault polygon has been extracted from (e.g., or picked), points of the polygon may be specified as having the same value or approximately the same value. As an example, where thickness between two successive seismic horizons may be uncertain (e.g., interpretations are lacking in a portion of a seismic cube), a method may include constraining an unknown iso-value of an implicit function to go through a plurality of interpretation points. As an example, a method may include controlling shape or shapes of one or more horizons where, for example, seismic events have been interpreted using an extrema technique and where correspondence has not yet been established for extrema patches. In such an example, a constraint may specify that points of a patch correspond to a particular value.

As an example, a constraint may be set with respect to fault information. For example, consider fault displacement as a constraint. In such an example, a linear constraint may constrain at least two points, for example, located on opposite sides of a fault. In such an example, two or more points may be constrained to have a common value (e.g., of an unknown) of an implicit function. As an example, a value of a point may be constrained as to slope with respect to a value of another point. As an example, for two or more points, a constraint may be a range of values within which respective values of the two or more points are to exist.

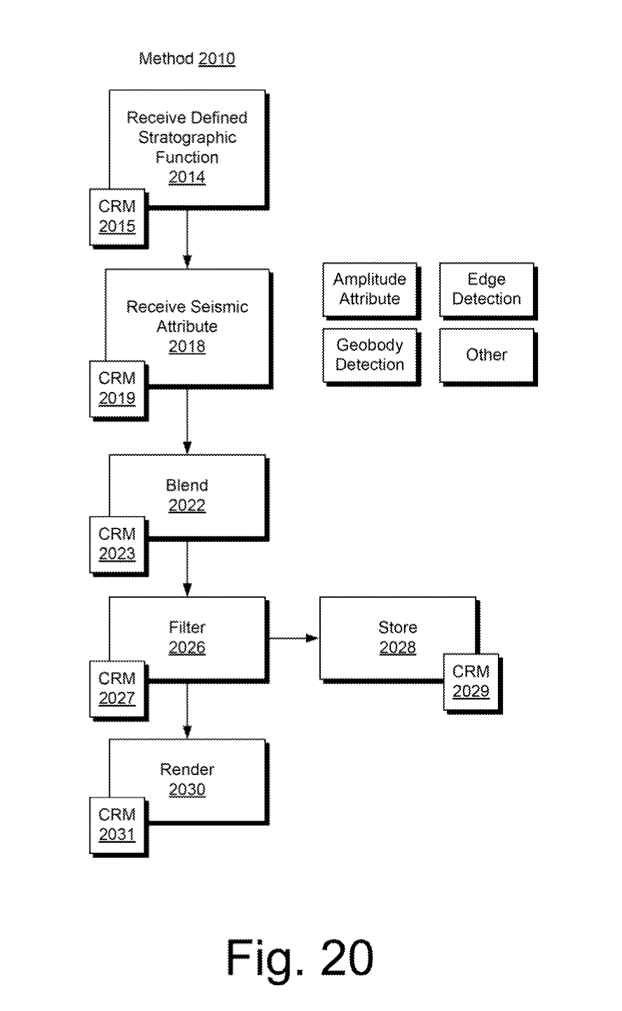

FIG. 20 shows an example of a method 2010 that includes a reception block 2014 for receiving a defined stratigraphic function, a reception block 2018 for receiving a seismic attribute, and a blend block 2022 for blending the defined stratigraphic function and the seismic attribute. In such an example, the method 2010 may include a filter block 2026 for filtering information based at least in part on the defined stratigraphic function. As an example, a result from filtering may be stored by a storage block 2028 and/or rendered by a rendering block 2030.

The method 2010 is shown in FIG. 20 in association with various computer-readable media (CRM) blocks 2015, 2019, 2013, 2027, 2029 and 2031. Such blocks generally include instructions suitable for execution by one or more processors (or cores) to instruct a computing device or system to perform one or more actions. While various blocks are shown, a single medium may be configured with instructions to allow for, at least in part, performance of various actions of the method 2010. As an example, a computer-readable medium (CRM) may be a computer-readable storage medium. As an example, the blocks 2015, 2019, 2013, 2027, 2029 and 2031 may be provided as one or more modules, for example, such as the one or more modules 407 of the system 401 of FIG. 4.

As an example, a method may include applying continuous and high resolution stratal-slicing. For example, consider a workflow as follows: blending a stratigraphic function with one or more seismic attributes (amplitudes, edge detection, body detection, etc.); using the stratigraphic function as a filter and visualizing one or more of the one or more seismic attribute for one or more iso-values of the stratigraphic function (e.g., to see the blended attribute for a conformable event in the seismic volume); and storing (e.g., optionally automatically) a view for a given iso-value of the stratigraphic function (generation of a height field) with a list of attributes. In such an example, storing may be performed for one or more iso-values, for example, optionally for a range of iso-values.

As an example, a method may include applying for a dip constrained attribute computation. For example, a stratigraphic function may represent the best dip one can have as it includes manual user interpreted inputs as well as a global dip estimation field. In such an example, uncertainty on the dip field derived from the stratigraphic function may be used as a guide for one or more attribute computations, for example, one or more computations that may benefit from dip correction to enhance results (e.g. curvature, variance, etc.).

As an example, a method may include using a stratigraphic function for property modeling. For example, a stratigraphic function may provide for a high resolution structural model of a sub-surface volume characterized by a seismic survey area and depth of acquisition. In such an example, the latter may be up-scaled, for example, to a desired resolution, and used to create a suitable space for property modeling. As an example, following an iso-value of a stratigraphic function may give a surface in space representing a deformed paleo-topography (cf. deformed by tectonic and subsidence). As an example, where a method includes receiving property values in space (e.g., as from one or more logs), one or more values intersecting a stratigraphic function iso-value may be used as inputs for interpolation (e.g., using existing property modeling algorithm). Such an example may operate in a sim-box-like space (e.g., a Cartesian x,y,T space, etc.) and, for example, may be mapped back onto a corresponding iso-value of the stratigraphic function. As an example, an approach may allow for disabling one or more constraints linked to physically build a Cartesian x,y,T space (e.g. a pillar grid, etc.).

As an example, a method can include generating an implicit function as part of a workflow such as, for example, a workflow performed at least in part via a volume-based structural framework. In such an example, the method may include receiving dip information such as, for example, a dip attribute that may be a seismic “consistent dip” attribute cube. As an example, the method may process the dip information in combination with the implicit function to increase resolution of information, for example, beyond the resolution of the implicit function. Such a method may, for example, generate a stratigraphic function by “flexing” a “relative age cube” locally and “morphing” seismic reflector topology onto it.

As an example, a method may be applied to one or more of a variety of geometries. For example, consider shallow geometries that may exhibit some deformation and deeper geometries that may exhibit more deformation.

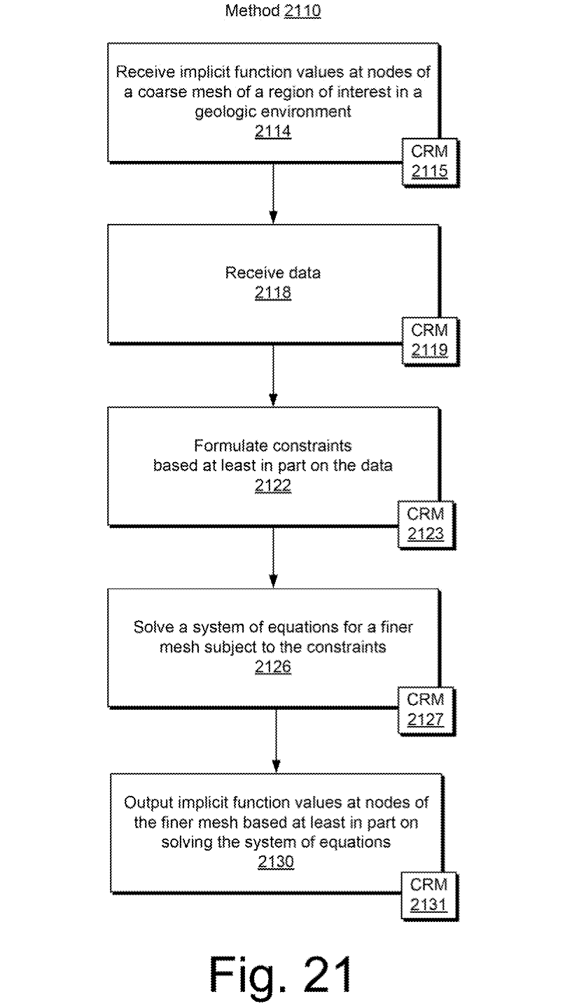

FIG. 21 shows an example of a method 2110 that includes a reception block 2114 for receiving implicit function values at nodes of a coarse mesh of a region of interest in a geologic environment; a reception block 2118 for receiving data; a formulation block 2122 for formulating constraints based at least in part on the data; a solution block 2126 for solving a system of equations for a finer mesh subject to the constraints; and an output block 2130 for outputting implicit function values at nodes of the finer mesh based at least in part on solving the system of equations. As an example, the implicit function output by the output block 2130 may be a stratigraphic function. For example, an iso-value of an implicit function may represent a conformable depositional event that takes into account tectonic stages. In such an example (e.g., context), one may consider implicit function and stratigraphic function to be synonymous.

The method 2110 is shown in FIG. 21 in association with various computer-readable media (CRM) blocks 2115, 2119, 2123, 2127 and 2131. Such blocks generally include instructions suitable for execution by one or more processors (or cores) to instruct a computing device or system to perform one or more actions. While various blocks are shown, a single medium may be configured with instructions to allow for, at least in part, performance of various actions of the method 2110. As an example, a computer-readable medium (CRM) may be a computer-readable storage medium. As an example, the blocks 2115, 2119, 2123, 2127 and 2131 may be provided as one or more modules, for example, such as the one or more modules 407 of the system 401 of FIG. 4.

As an example, a method can include receiving implicit function values at nodes of a coarse mesh of a region of interest in a geologic environment; receiving data; formulating constraints based at least in part on the data; solving a system of equations for a finer mesh subject to the constraints; and outputting implicit function values at nodes of the finer mesh based at least in part on solving the system of equations. Such a method may include solving the system of equations for residual values.

As an example, a method may include interpolating implicit function values at nodes of a coarse mesh to provide interpolated implicit function values at nodes of a finer mesh. In such an example, a method may include adding the residual values and the interpolated implicit function values (e.g., to output high resolution implicit function values).

As an example, a method may include using at least one processor to solve a system of equations. As an example, implicit function values at nodes of a finer mesh may be stratigraphic function values.

As an example, data may be or include seismic data. Such data may include a spatial resolution for a region of interest that is higher than a spatial resolution for nodes of a coarse mesh. As an example, data may be or include attribute values. As an example, data may be or include dip data. As an example, data may include confidence values. As an example, a method may include introducing weights based at least in part on confidence values.

As an example, a method can include receiving data that includes dip vectors. In such an example, constraints of a linear system of equations can include linear gradient constraints based at least in part on the dip vectors. As an example, one or more linear gradient constraints can be formulated according to a Gram-Schmidt algorithm. As an example, one or more linear gradient constraints may be weighted. For example, linear gradient constraints can include one or more weights. As an example, a weight may correspond to a quantifiable quality of a vector such as, for example, a dip vector. As an example, weights may correspond to quantifiable qualities of dip vectors, which may be relative (e.g., relative to a set of dip vectors, etc.).

As an example, implicit function values at nodes of a coarse mesh may be or include values based on human visual interpretation.

As an example, a method may include interpolating implicit function values at nodes of a finer mesh to provide interpolated implicit function values at additional locations in a region of interest.

As an example, a system may include a processor; memory operatively coupled to the processor; and one or more modules that include instructions stored in the memory and executable by the processor to instruct the system where the instructions can include instructions to: receive implicit function values at nodes of a coarse mesh of a region of interest in a geologic environment; receive data; formulate constraints based at least in part on the data; solve a system of equations for a finer mesh subject to the constraints to provide a solution; and output implicit function values at nodes of the finer mesh based at least in part on a solution the system of equations. In such an example, the data may be or include seismic data. As an example, data may be or include vectors. As an example, data may be or include dip vectors. As an example, data may be or include attribute values.

As an example, one or more computer-readable storage media may include computer-executable instructions to instruct a computing device where the instructions can include instructions to: receive implicit function values at nodes of a coarse mesh of a region of interest in a geologic environment; receive data; formulate constraints based at least in part on the data; solve a system of equations for a finer mesh subject to the constraints to provide a solution; and output implicit function values at nodes of the finer mesh based at least in part on a solution the system of equations. In such an example, data may be or include seismic data. As an example, data may be or include vectors. As an example, data may be or include dip vectors. As an example, data may be or include attribute values.

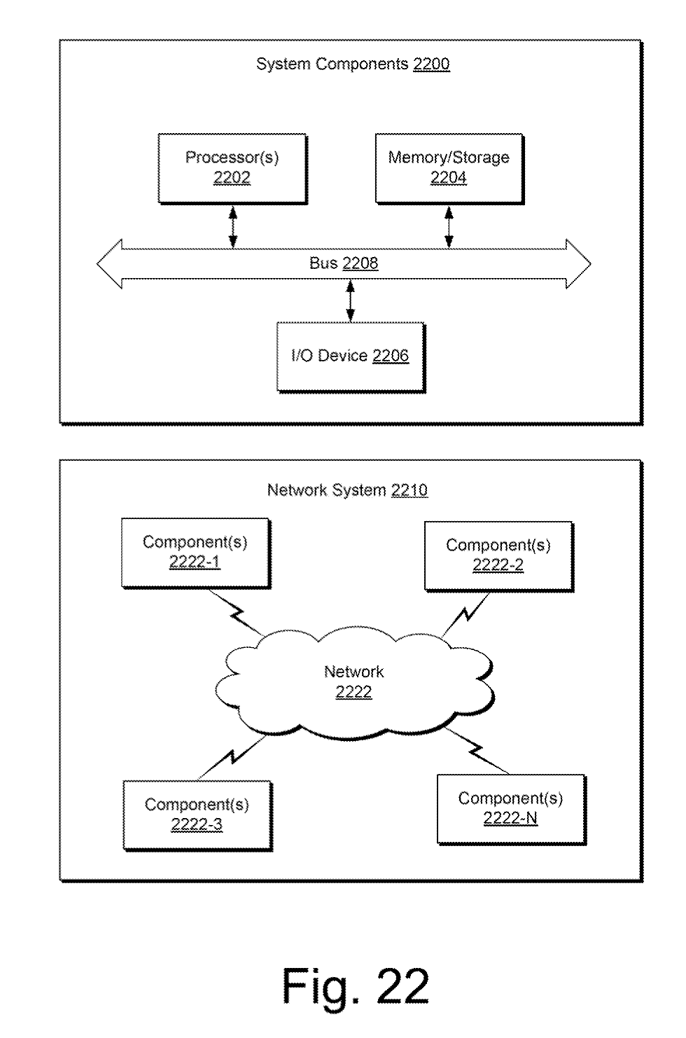

FIG. 22 shows components of an example of a computing system 2200 and an example of a networked system 2210. The system 2200 includes one or more processors 2202, memory and/or storage components 2204, one or more input and/or output devices 2206 and a bus 2208. In an example embodiment, instructions may be stored in one or more computer-readable media (e.g., memory/storage components 2204). Such instructions may be read by one or more processors (e.g., the processor(s) 2202) via a communication bus (e.g., the bus 2208), which may be wired or wireless. The one or more processors may execute such instructions to implement (wholly or in part) one or more attributes (e.g., as part of a method). A user may view output from and interact with a process via an I/O device (e.g., the device 2206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2210. The network system 2210 includes components 2222-1, 2222-2, 2222-3, . . . 2222-N. For example, the components 2222-1 may include the processor(s) 2202 while the component(s) 2222-3 may include memory accessible by the processor(s) 2202. Further, the component(s) 2202-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11. ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving implicit function values at nodes of a coarse mesh of a region of interest in a geologic environment;
receiving data;
formulating constraints based at least in part on the data;
solving a system of equations for a finer mesh subject to the constraints; and
outputting implicit function values at nodes of the finer mesh based at least in part on solving the system of equations.

2. The method of claim 1 wherein the solving comprises solving the system of equations for residual values.

3. The method of claim 1 comprising interpolating the implicit function values at the nodes of the coarse mesh to provide interpolated implicit function values at the nodes of the finer mesh.

4. The method of claim 3 wherein the outputting comprises adding the residual values and the interpolated implicit function values.

5. The method of claim 1 wherein the solving comprises using at least one processor.

6. The method of claim 1 wherein the implicit function values at the nodes of the finer mesh comprise stratigraphic function values.

7. The method of claim 1 wherein the data comprise dip vectors.

8. The method of claim 7 wherein the constraints comprise linear gradient constraints based at least in part on the dip vectors.

9. The method of claim 8 wherein the linear gradient constraints are formulated according to a Gram-Schmidt algorithm.

10. The method of claim 8 wherein the linear gradient constraints comprise weights.

11. The method of claim 10 wherein the weights correspond to quantifiable qualities of the dip vectors.

12. The method of claim 1 wherein the data comprise confidence values.

13. The method of claim 12 further comprising introducing weights based at least in part on the confidence values.

14. The method of claim 1 wherein the data comprise a spatial resolution for the region of interest that is higher than a spatial resolution for the nodes of the coarse mesh.

15. A system comprising:
a processor;
memory operatively coupled to the processor; and
one or more modules that comprise instructions stored in the memory and executable by the processor to instruct the system wherein the instructions comprise instructions to:
receive implicit function values at nodes of a coarse mesh of a region of interest in a geologic environment;
receive data;
formulate constraints based at least in part on the data;
solve a system of equations for a finer mesh subject to the constraints to provide a solution; and
output implicit function values at nodes of the finer mesh based at least in part on a solution the system of equations.

16. The system of claim 15 wherein the data comprise dip vectors.

17. The system of claim 15 wherein the data comprise attribute values.

18. One or more computer-readable storage media that comprise computer-executable instructions to instruct a computing device, the instructions comprising instructions to:
receive implicit function values at nodes of a coarse mesh of a region of interest in a geologic environment;
receive data:
formulate constraints based at least in part on the data;
solve a system of equations for a finer mesh subject to the constraints to provide a solution; and
output implicit function values at nodes of the finer mesh based at least in part on a solution the system of equations.

19. The one or more computer-readable storage media of claim 18 wherein the data comprise dip vectors.

20. The one or more computer-readable storage media of claim 18 wherein the data comprise attribute values.
